(19) United States
(12) Patent Application Publication
(10) Pub. No.: US 2020/0385151 A1
(43) Pub. Date: Dec. 10, 2020

(54) BLANK, METHOD OF MANUFACTURING A SET OF BELTS, METHOD AND MACHINE FOR PACKAGING PRODUCTS IN A BOX MADE OF TWO BELTS

(71) Applicant: DS SMITH PLC, London (GB)

(72) Inventor: Didier DESERTOT, ARC SUR TILLE (FR)

(21) Appl. No.: 16/604,958

(22) PCT Filed: Apr. 12, 2018
(86) PCT No.: PCT/EP2018/059455

§ 371 Date: Oct. 11, 2019

(30) Foreign Application Priority Data
Apr. 13, 2017 (EP) 17000631.6

(51) Int. Cl. B65B 5/02; B31B 50/04; B31B 50/36; B65B 59/00; B65B 43/08; B65D 5/32; B65B 35/24; B65B 65/00

(52) U.S. Cl. CPC B65B 5/028; B31B 50/042; B31B 50/36; B65B 59/003; B31B 2105/0025; B65D 5/324; B65B 35/24; B65B 65/003; B65B 43/08

(57) ABSTRACT

The invention relates to a blank of corrugated cardboard sheet material consisting of a first body (10) and a second body (11) of rectangular shape which are connected together by means of a line to be cut and designed for forming a set of a first belt and a second belt intended to form a box having a length L, a width W and a height H, the first and the second bodies having different widths and lengths and the line extending along the length of the first and second bodies, the first body (10) having a width (D1) larger than the length L and a length (D2) larger than at least twice the width W plus the height H (2W+H) and the second body (11) having a width (d1) larger than the width W or the height H and a length (d2) larger than the length L plus twice the height H or twice the width W.

The present invention relates to a method and a machine for packaging products in a box of corrugated cardboard sheet material designed to have an inner space close to the size of the products which are intended to be housed in the box. This box is called a RSP box (Right Size Packaging box).

This box has a polygonal cross-section and is made from two belts.

The invention also relates to blanks and to a method of manufacturing a set of belts from a blank which allow such a box to be obtained.

A particularly important, though non-exclusive, use involves the field of boxes used for packaging online orders.

E-fulfillment companies face the problem of quickly packaging a high volume of products which can be all different in size.

One solution can be to have a limited number of alternative packagings, to select the one most adapted to the product to be packed and to use blocking and filling material to hold the product in place in the packaging.

It has also been proposed to measure the product with a 3D scanner in order to cut the carton to the right size, the carton being then folded around the product and the edges of the box glued in order to close the box.

With this solution, there is no need for padding material, since the carton is cut exactly to the right size.

It still have some drawbacks since the final box cannot be reused after it has been opened, thus preventing a customer to use the box for sending back the product to the sender for exchange.

Reference is made to WO2016/059218 which relates to a system and method for packaging items varying in size and number.

The minimum dimensions of the packaging are calculated with the information about the size of the item(s) to be packaged.

The package includes an inner part, first wrapped around the items, and an outer part wrapped around the inner part, to enclose the packaged item(s) from all sides.

Such a combined package cannot be reused after it has been opened.

Moreover, a packaging is currently used for several products and wrapping a carton around them is difficult without holding them together. Therefore, additional means such as a wrapping film are necessary and are detrimental to the costs of the packaging.

An object of the present invention is to provide a method and a machine for packaging a product or several products (hereafter called product(s)) in a box of corrugated cardboard sheet of material which has a polygonal cross-section and which better complies with the requirements of the e-fulfillment practice than previously known packages, in particular in that it allows the disadvantages of known packages to be overcome, by using less material and therefore reducing the waste of material, by avoiding the use of a wrapping film and/or of blocking and filling material and by providing a re-usable box, while allowing automatic packaging formation in an easy, automatic and efficient manner.

The method and the machine according to the invention are both based on the acquisition of size information concerning the product(s) to be packed, this size information being used to determine the length L, the width W and the height H of the box designed for the product(s), i.e. designed to have an inner space close to the size of the product(s) which are intended to be housed in the box.

In all the specification, the length L, the width W and the height H of a box are determined by the following condition: the length L is larger than the width W which is larger than the height H.

The method and the machine according to the invention involve the use of special blanks which are designed to be readily adapted to the size of the final box while reducing the amount of material needed to manufacture the final box and the waste of material, in particular during the manufacturing of the box.

The invention proposes a blank of corrugated cardboard sheet material comprising a first body and a second body of rectangular shape which are connected together by means of a separation line to be cut and designed for forming a set of a first belt and a second belt intended to form a box having a length L, a width W and a height H, the first and the second bodies having different widths and lengths and the line extending along the length of the first and second bodies, wherein advantageously, the first body has a width (D1) larger than the length L and a length (D2) larger than at least twice the width W plus the height H and the second body has a width (d1) larger than the width W or the height H and a length (d2) larger than the length L plus twice the height H or twice the width W;

In a preferred embodiment, the first body and the second body are linked together by a separation line which comprises alternate portions of cut and portions of perforations, the first or the second body including tabs, each of them defined by one of said portions of perforations and two cuts connecting the said portion of perforations to a fold line parallel to said portion of perforations.

In advantageous embodiments, use is further and/or also made of one and/or other of the following arrangements:
The first belt having at least three rectangular panels intended to form at least the bottom, the first lateral wall and the top of the box and at least one pair of first flaps being connected on opposing sides of one of said panels, the width (D1) of the first body is equal to or larger than the length L plus twice the width w′ of a first flap of the box.
The first belt having at least three rectangular panels intended to form at least the bottom, the first lateral wall and the top of the box and the panel intended to form the top of the box being connected to a third flap which is intended to be glued on the second lateral wall to close the box, the length (D2) of the first body is equal to or larger than the height H plus twice the width W plus the width w of said third flap.
The second belt comprising a central panel, having dimensions corresponding to the ones of the panel of the first belt intended to form the bottom of the box and two secondary panels, each of them connected to a flap, the length (d2) of the second body is equal to or larger than the length L plus twice the height H and the width of said flap.

The invention also relates to a method of manufacturing a set of a first belt and a second belt from a blank of according to the invention and provided in a stack of blanks (A12 to A32), the first and second belts being intended to form a box having a length L, a width W and a height H close to the size of the products to be housed in the box, wherein, after removal of the blank from the stack, the first body and the second body are separated, at least one body being then cut to reduce its length and/or its width (D1, d1; D2, d2) so that it is adapted to the dimensions of the first belt or of the second belt and wherein at least two first parallel fold lines are created in the first body to define at least three main panels of the first belt which are intended to form at least the bottom, the first lateral wall and the top of the box, wherein the main panels intended to form the bottom and the top of the box define the length L and the width W of the box while the main panel intended to form the first lateral wall defines the length L and the height H of the box, and in the second body to define at least a central panel and two secondary panels of the second belt, wherein the secondary panels are intended to form the third and fourth lateral walls of the box and define the height H and the width W of the box. In advantageous embodiments, use is further and/or also made of one and/or other of the following arrangements:
Second fold lines, perpendicular to the first fold lines, are created in the first body to define at least one pair of first flaps of the first belt which are connected on opposing sides of one of said main panels by means of said second fold lines.
A fourth fold line parallel to said first fold lines is created in the first body to define a third flap connected to the main panel forming the top of the box.
Only the second body is cut when the length (D2) of the first body is less than twice the width W of the box plus three times the height H of the box.
The central panel of the second belt has dimensions falling within the ones of the main panel of the first belt intended to form the bottom of the box, the first and second belts being intended to be connected together by means of the central panel of the second belt and of the main panel of the first belt forming the bottom of the box, which are overlaid on each other, said first and second belts thus connected being in the shape of a cross.
Three first parallel fold lines are created in the first body to define four main panels in the first belt, one of them forming the second lateral wall of the box.
Four first parallel fold lines are created in the second body to define a flap connected to each of the secondary panels of the second belt, by means of one of said first fold lines.
The central panel of the second belt is designed to form the second lateral wall of the box and has dimensions corresponding to the length L and the height H of the box, the belts being intended to be connected together to form a T-Shape.
The first body and the second body are linked together by a separation line which comprises alternate portions of cut and portions of perforations, the first or the second body including tabs, each of them defined by a portion of perforations and two cuts connecting the said portion of perforations to a fold line parallel to said portion of perforations, the first and the second bodies being separated by punching the tabs to break the portions of perforations.

The invention also concerns a method of packaging at least one product in a box comprising the step of:
measuring the size of the product(s)
determining the length L, the width W and the height H of the box closely adapted to the size of the product(s) to be packed in the box
choosing a blank corresponding to the length L, the width W and the height H of the box, and according to the invention
manufacturing a set of a first belt and a second belt with the method according to the invention, from said blank
gluing the belts together in a cross shape or a T shape
erecting a box from the joined belts
placing the products(s) in the box and
closing the box.

The products are preferably introduced laterally in the box.

Finally, the invention relates to a machine for packaging at least one product in a box comprising:
a unit D for preparing the products and measuring their size
means for determining the length L, the width W and the height H of the box closely adapted to the size of the products to be packed in the box
means for determining a type of blank of corrugated cardboard material corresponding to the length L, the width W and the height H of the box and according to the invention
a unit A including at least two stacks (A12 to A32) of blanks of different types (T1 to T3)
a unit B including splitting means (B4) for separating the first body and the second body of said blank and a first body transformation line, respectively a second body transformation line to transform the first body, respectively the second body into a first belt, respectively a second belt
a unit C for joining the first and second belts in a cross shape or a T shape, and for forming the joined belts into an at least partially erected box F and
a unit E for the filling the at least partially erected box F with the products for which it is designed and for closing the box.

In advantageous embodiments, use is further and/or also made of one and/or other of the following arrangements:
in unit A, the at least two stacks (A12 to A32) of blanks are provided on vertically movable pallets (A1 to A3);
the first body transformation line, respectively the second body transformation line includes cutting means for reducing the length and/or the width of the first body, respectively the second body;
the first body transformation line, respectively the second body transformation line includes means for creating fold lines in the first body, respectively in the second body.
it includes a robot for joining the first belt and the second belt in a cross shape or a T shape.
unit D comprises crates for the transportation of the products, each of them including a bottom, two lateral sides, one of them being fixed and the other movable, and a retractable backside, the unit E for filling the products being arranged to fill said products laterally.

The invention therefore proposes a box of corrugated cardboard sheet material exhibiting a polygonal cross section and having a top, a bottom and four lateral walls, the first and second ones, respectively the third and fourth ones being opposite each other, wherein said box has a length L, a width W and a height H close to the size of the products to be housed in the box and comprises a first belt and a second belt, each belt having at least three rectangular panels with parallel first fold lines extending between two adjacent panels, said rectangular panels of the first belt comprising three main panels which form at least the bottom, the first lateral wall and the top of the box, said rectangular panels of the second belt comprising a central panel and two secondary panels provided on each side of said central panel, the secondary panels forming the third and fourth lateral walls of the box, the second lateral wall of the box being formed by the first or the second belt and the belts being glued together in a position where the first fold lines of the first belt are perpendicular to the first fold lines of the second belt to form joined belts.

In advantageous embodiments, use is further and/or also made of one and/or other of the following arrangements:
the first belt comprises at least one pair of first flaps connected on opposing sides of one of said main panels by means of parallel second fold lines, perpendicular to the first fold lines and glued on the third and fourth lateral walls of the box;
the main panel forming the top of the box is connected to a third flap by means of a fourth fold line parallel to said first fold lines, this third flap being intended to be glued on the second lateral wall to close the box;
the central panel of the second belt has dimensions falling within the ones of the main panel of the first belt forming the bottom of the box and the first and second belts are connected together by means of the central panel of the second belt and the main panel of the first belt forming the bottom of the box, which are overlaid on each other, said first and second belts thus connected to form said joined belts being in the shape of a cross;
the central panel of the second belt is located inside the box;
the first belt comprises four main panels, one of them forming the second lateral wall of the box;
two pairs of first flaps are provided on the opposing sides of the main panels of the first belt forming the first and the second lateral walls of the box;
two pairs of second flaps are provided on the opposing sides of the main panels of the first belt forming the top and the bottom of the box, these flaps being folded and glued on these panels;
the second flaps are located inside the box;
at least each of the first flaps of the main panels of the first belt forming the first and second lateral walls of the box is provided with an intermediate fold line, extending between the second fold line connecting the said first flap to the adjacent main panel and the free edge of the flap and parallel to said second fold line, this intermediate fold line defining an intermediate flap which is folded toward the interior of the box and glued to the said adjacent panel;
each of the secondary panels of the second belt is connected to a flap by means of a first fold line of the second belt, these flaps being folded toward the interior of the box;
the central panel of the second belt forms the second lateral wall of the box, the joined belts being T-Shaped;
the main panel of the first belt forming the bottom of the box is connected to a fourth flap, the first and the second belts being glued together by means of this fourth flap;
two pairs of first flaps are provided on the opposing sides of two of the main panels of the first belt forming the bottom and the first lateral wall of the box which are glued on the secondary panels of the second belt;
the first belt also comprises a pair of second flaps on the opposing sides of its main panel forming the top of the box, these second flaps being folded and glued on the secondary panels of the second belt;
one pair of first flaps is provided on the main panel of the first belt forming the first lateral wall of the box, each of said first flaps being provided with an intermediate fold line extending between the second fold line and the free edge of said first flap, this intermediate fold line defining with said second fold line an intermediate flap which is folded toward the interior of the box and glued to the said main panel and wherein the second belt comprises an intermediate panel between the central panel and each of the secondary panels, defined by a first fold line of the second belt and an intermediate fold line, the intermediate panels being folded toward the central panel and glued to it.

The invention also concerns an assembly of a box according to the invention and of product(s) for which it is designed.

In other words, the invention also concerns an assembly of at least one product and a box according to the invention which is made of two belts joined together to present a cross shape or a T shape and comprises a top, a bottom and four lateral walls, each of them having an outer face and an inner face, these six inner faces defining an inner space in which the at least one product is housed.

When the box is designed for only one product, the length L, the width W and the height H of the box are chosen so that the product is in tight contact with at least two different inner faces of the box to be held in place in the box, and preferably with each inner face of the box.

When the box is designed for housing at least two products, the products are assembled or stacked so that each product is in tight contact at least with another product and, when the products are housed in the box, each product is in tight contact with at least two among an inner face of the box and another product.

The assembly of the products is preferably in contact with each inner face of the box.

The contact between a product and another product or with an inner face of the box is along a side, a line, an edge, a surface or only a contact point.

In both cases, the box is therefore designed to avoid any movement of a product in the inner space defined by the box or any movement of a product with regard to another product housed in the box, and preferably, to limit the part of its inner space which is not filled with the product(s).

The invention also relates to a set of belts which is produced from a blank of corrugated cardboard sheet material and which is designed to form a box of polygonal cross-section and having a top, a bottom and four lateral walls, the first and second ones, respectively the third and fourth ones being opposite each other, said box having a length L, a width W and a height H close to the size of the products to be housed in the box wherein said set comprises a first belt and a second belt having each at least three rectangular panels with parallel first fold lines extending between two adjacent panels, said rectangular panels of the first belt comprising three main panels which form at least the bottom, the first lateral wall and the top of the box, said rectangular panels of the second belt comprising a central panel and two secondary panels provided on each side of said central panel, the secondary panels forming the third and fourth lateral walls of the box, and the first or the second belt forming the second lateral wall of the box.

In advantageous embodiments, use is further and/or also made of one and/or other of the following arrangements:
the first belt comprises at least one pair of first flaps connected on opposing sides of one of said main panels by means of parallel second fold lines, perpendicular to the first fold lines;
the main rectangular panel forming the top of the box is connected to a first flap by means of a fourth fold line parallel to said first fold lines;
the central panel of the second belt has dimensions falling within the ones of the main panel of the first belt forming the bottom of the box;
the first belt comprises four main panels, one of them forming the second lateral wall of the box;
two pairs of first flaps are provided on the opposing sides of the main panels of the first belt forming the first and the second lateral walls of the box;
two pairs of second flaps are provided on the opposing sides of the main panels of the first belt forming the top and the bottom of the box;
each of the first flaps of the main panels of the first belt forming the first and second lateral walls of the box is provided with an intermediate fold line extending between the second fold line connecting the said first flap to the adjacent main panel and the free edge of the flap and parallel to said second fold line, this intermediate fold line defining an intermediate flap;
each of the secondary panels of the second belt is connected to a flap by means of a first fold line of the second belt;
the central panel of the second belt forms the second lateral wall of the box.
the main panel of the first belt forming the bottom of the box is connected to a fourth flap, by means of first fold line of the first belt;
two pairs of first flaps are provided on the opposing sides of the main panels of the first belt forming the bottom and the first lateral wall of the box;
the first belt also comprises a pair of second flaps on the opposing sides of its main panel forming the top of the box;
one pair of first flaps is provided on the main panel of the first belt forming the first lateral wall of the box, each of said first flaps being provided with an intermediate fold line extending between the second fold line and the free edge of said first flap and parallel to said second fold line, this intermediate fold line defining with said second fold line an intermediate flap and wherein the second belt comprises an intermediate panel between the central panel and each of the secondary panels, defined by a first fold line of the second belt and an intermediate fold line parallel to said first fold line.

The invention relates to a method of forming a box having a top, a bottom and four lateral walls, the first and second ones, respectively the third and fourth ones being opposite each other, from a set of a first belt and a second belt made of corrugated cardboard sheet material having at least three main rectangular panels with first parallel fold lines extending between two adjacent panels, the first belt comprising three main panels which form at least the bottom, the first lateral wall and the top of the box, the second belt comprising a central panel which is provided on each side with a secondary panel, the secondary panels forming the third and fourth lateral walls of the box and the first or the second belt forming the second lateral wall of the box wherein, after production of the first belt and the second belt, the belts are glued together in a position where the first fold lines of the first belt are perpendicular to the first fold lines of the second belt and the box is then erected.

The invention will be better understood from a reading of the embodiments given below by way of non-limiting example. It refers to the drawings which accompany it and in which:

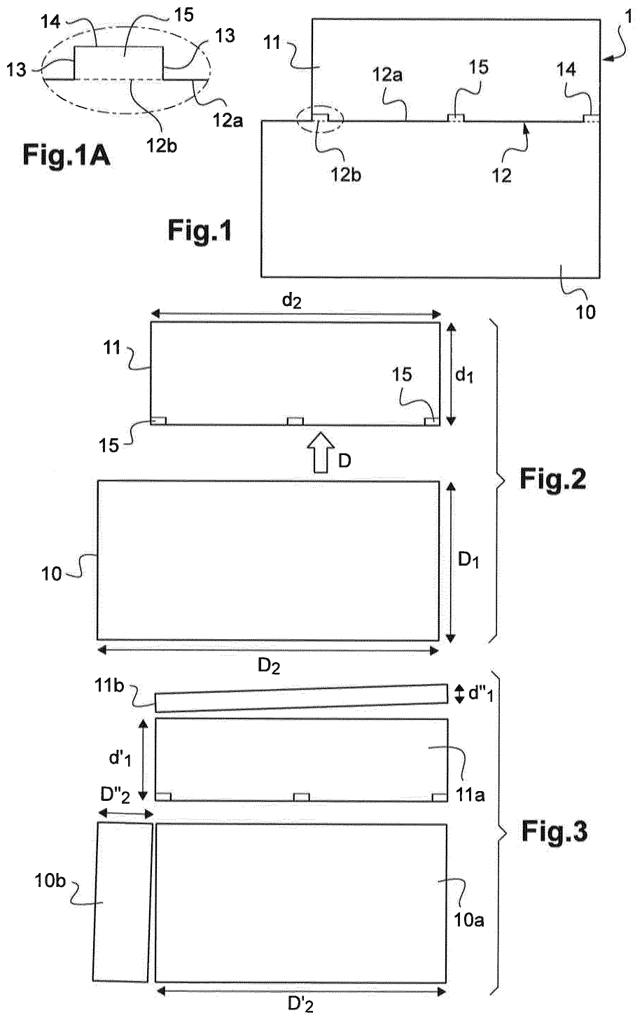

FIG. 1 is a top view of a blank according to a first embodiment of the invention.

FIG. 1A is an enlarged view of part of FIG. 1.

FIGS. 2 to 5 are top views of the blank of FIG. 1 showing the steps of forming a set of a first belt and a second belt from the blank.

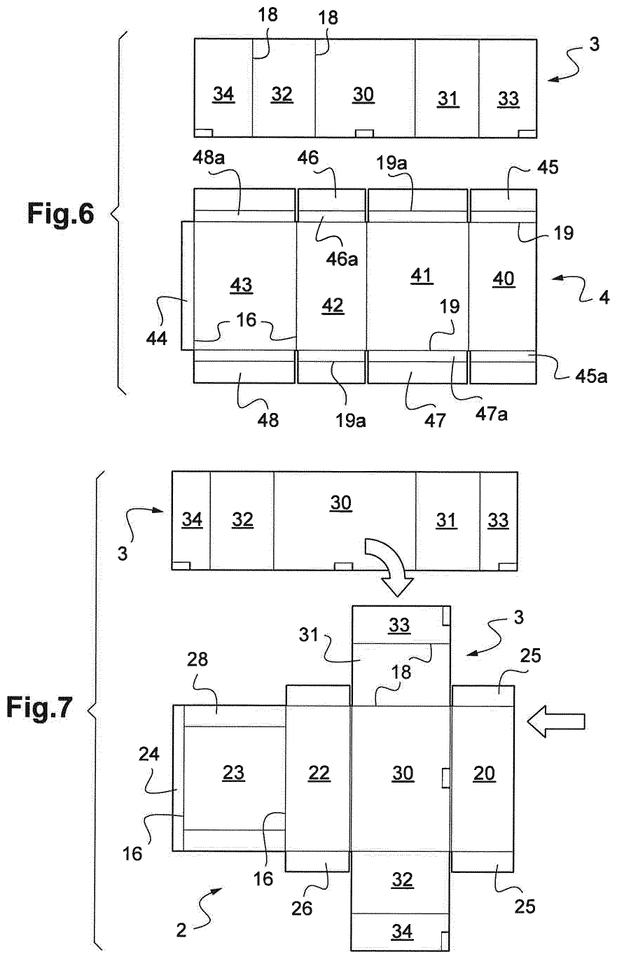

FIG. 6 is a top view of the first body and the second body showing a variant of the step illustrated in FIG. 5 in order to obtain a first belt and a second belt.

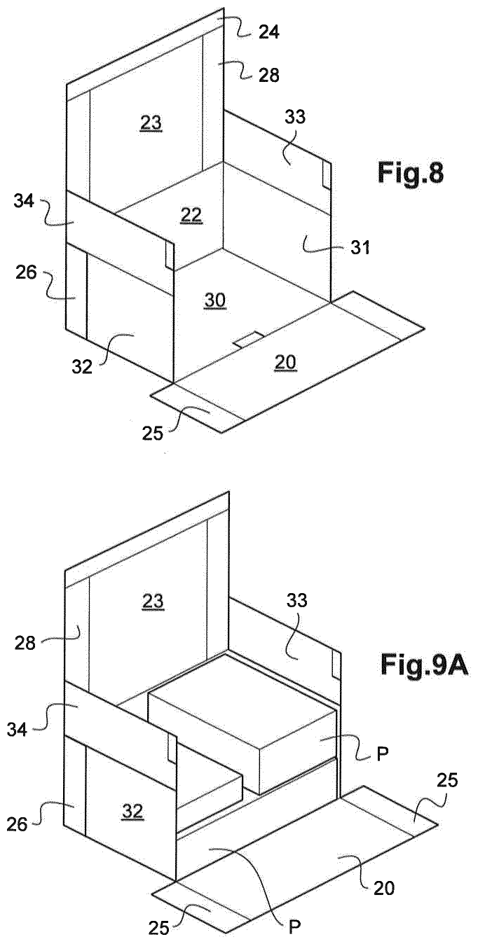

FIG. 7 is a top view of the first belt and the second belt illustrated in FIG. 5, showing a first step of the formation of a box.

FIG. 8 is a perspective view of a partially erected box made from the first and second belts illustrated on FIG. 7.

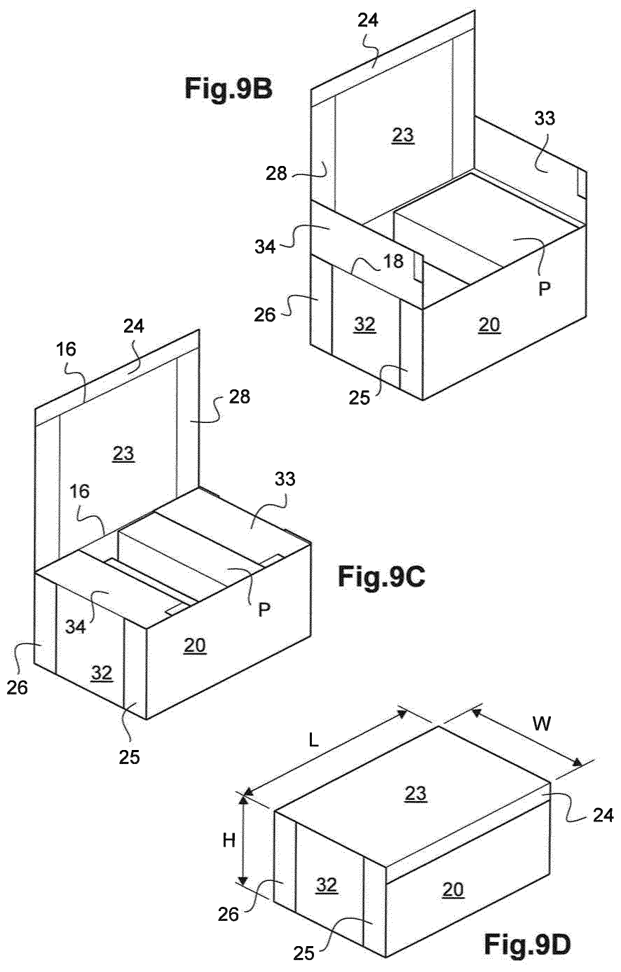

FIGS. 9A to 9D are perspective views of the box illustrated in FIG. 8 showing the steps of packaging items in said box.

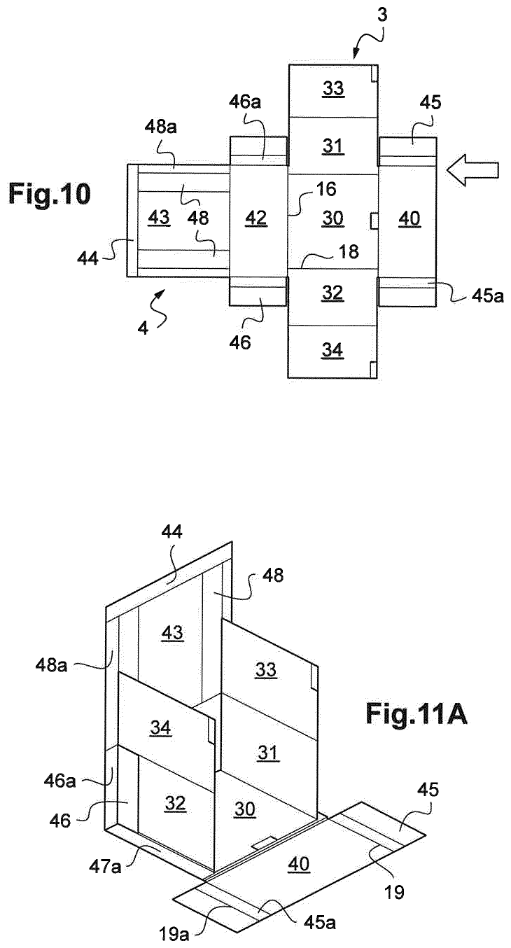

FIG. 10 is a top view of the first belt and the second belt illustrated in FIG. 6, showing a variant of the first step of the formation of a box.

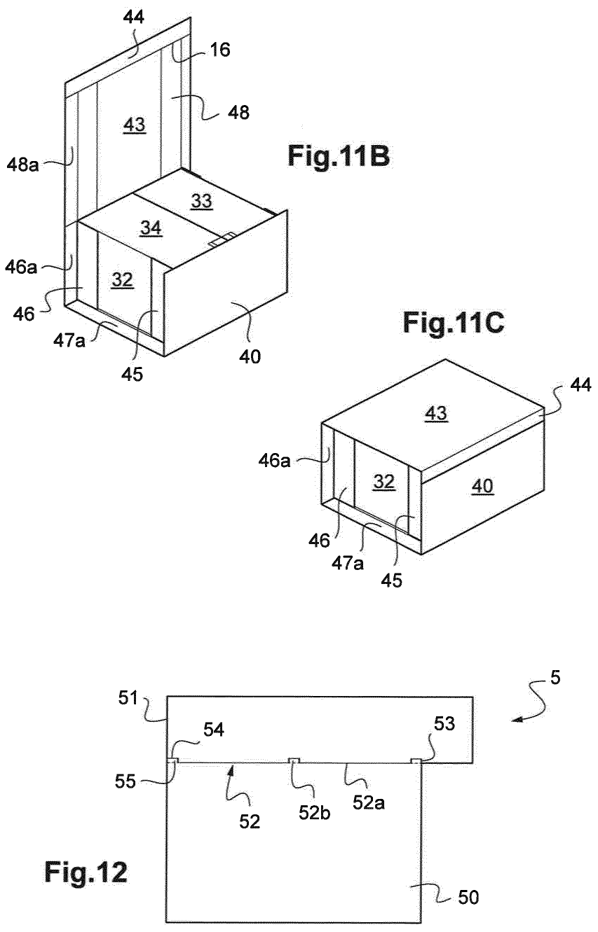

FIGS. 11A to 11C are perspective views of a partially erected box and of a closed box made from the first belt and the second belt illustrated in FIG. 10.

FIG. 12 is a top view of a blank according to a second embodiment of the invention.

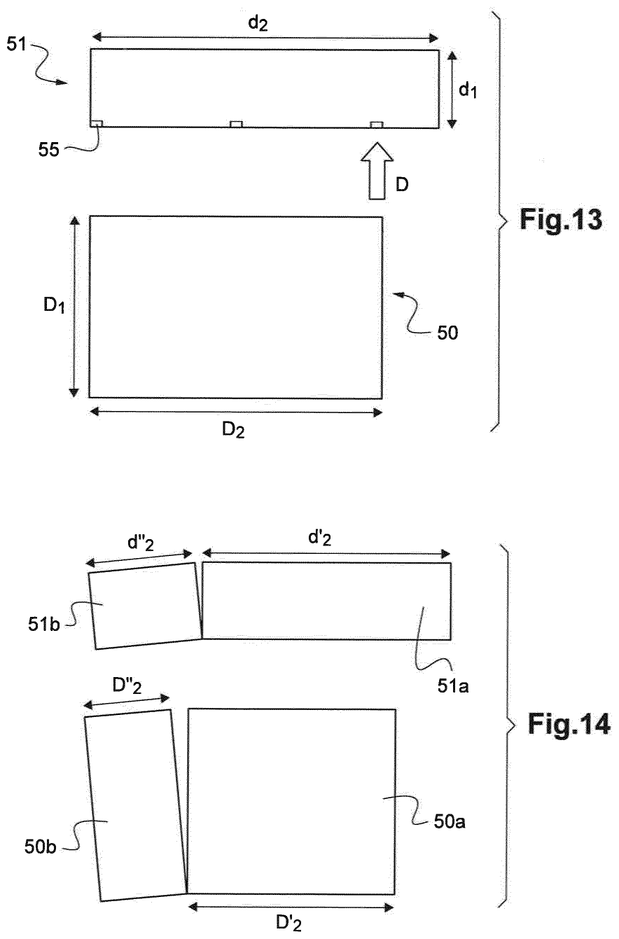

FIGS. 13 to 17 are top views of the blank of FIG. 12 showing the steps of forming a set of a first belt and a second belt from the blank.

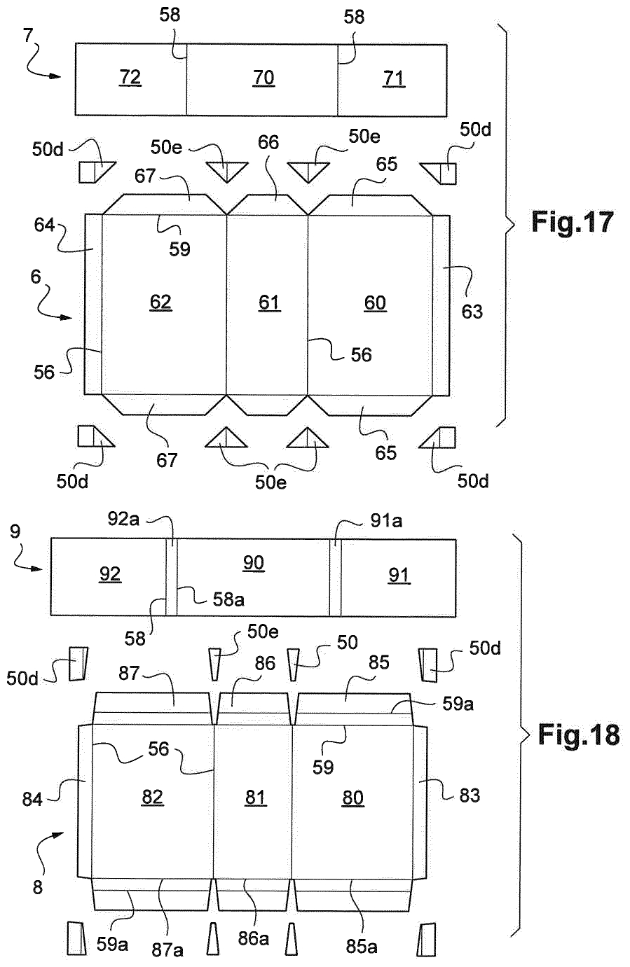

FIG. 18 is a top view of first body and the second body showing a variant of the step illustrated in FIG. 17 in order to obtain a first belt and a second belt.

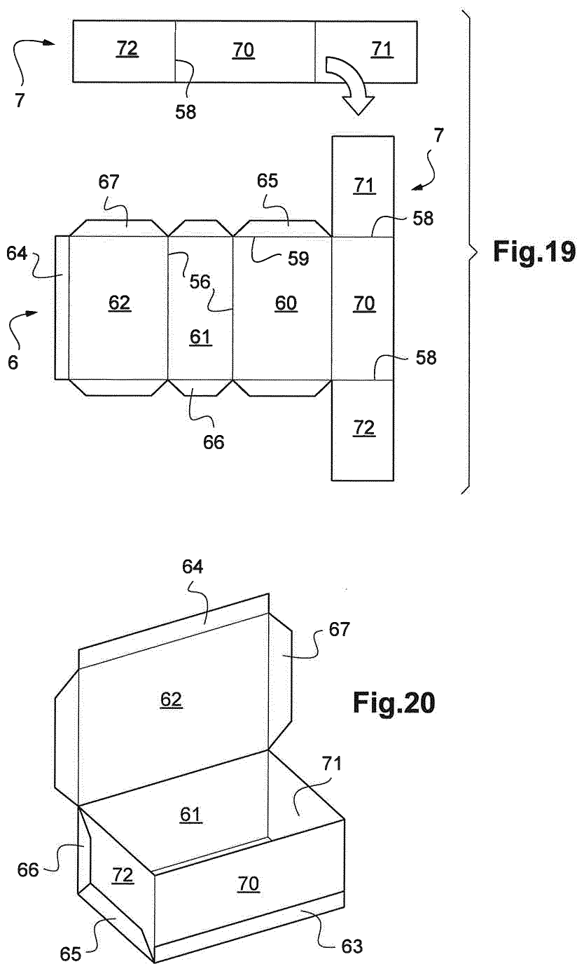

FIG. 19 is a top view of the first belt and the second belt illustrated in FIG. 17, showing a first step of the formation of a box.

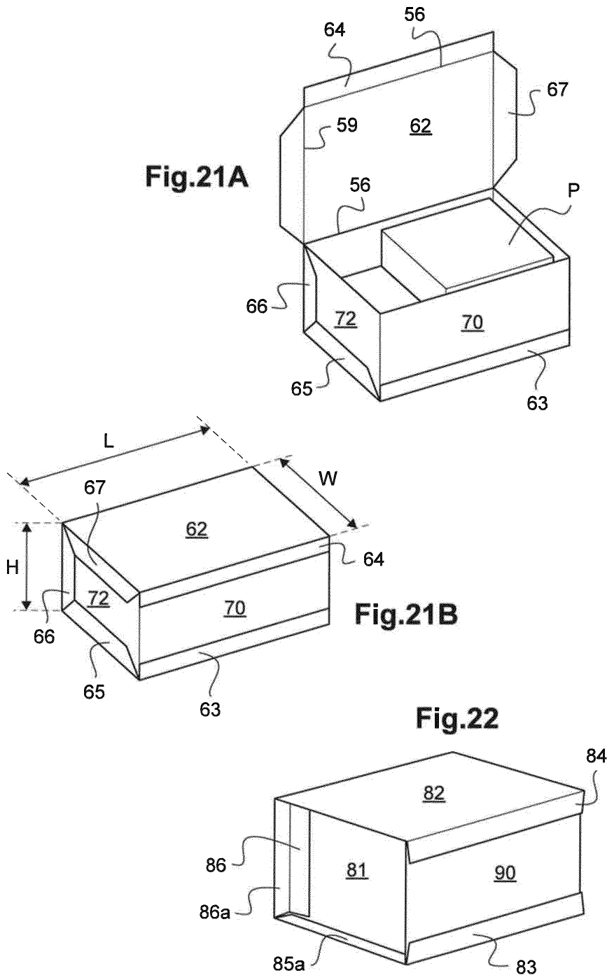

FIG. 20 is a perspective view of an erected box made from the first and second belts illustrated on FIG. 19.

FIGS. 21A and 21B are perspective views of the box illustrated in FIG. 20 showing the steps of packaging items in said box.

FIG. 22 is a perspective view of a closed box made from the first belt and the second belt illustrated in FIG. 18.

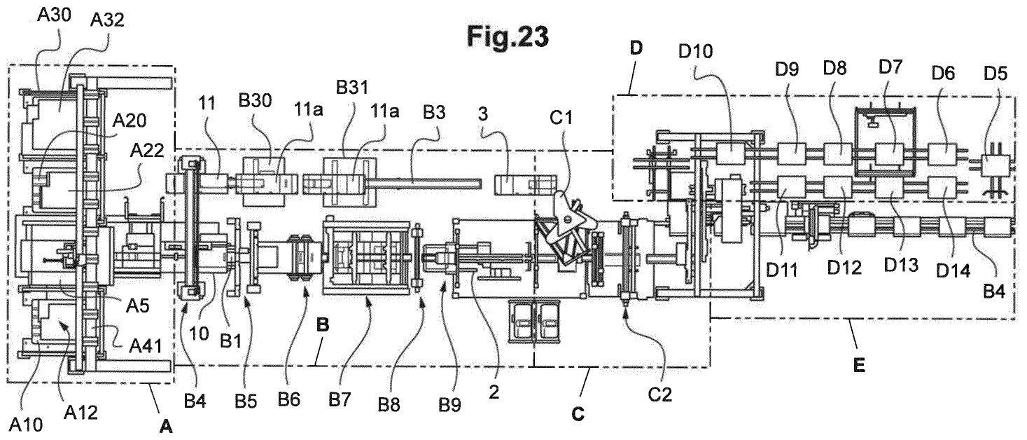

FIG. 23 is a plan view of an embodiment of a machine according to the invention, comprising units A to E.

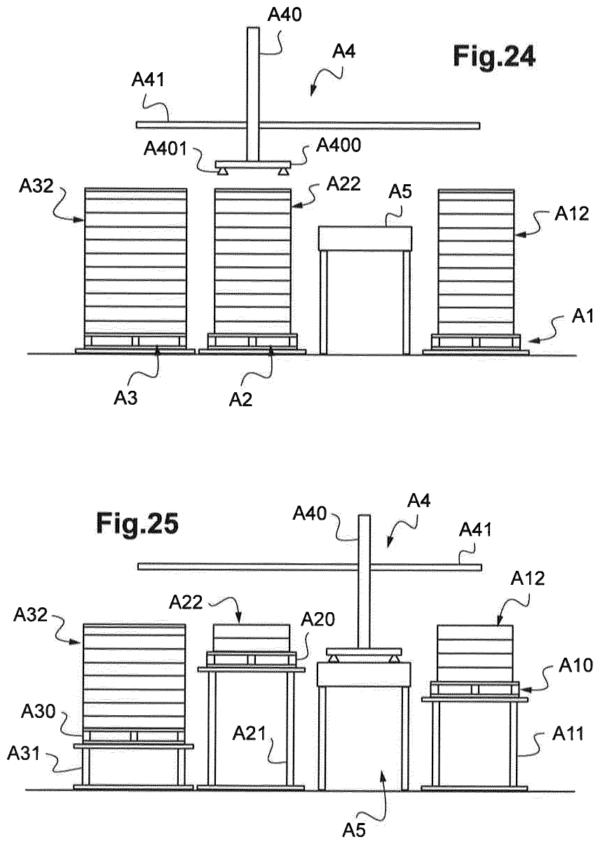

FIG. 24 is a side view of unit A (Storage and feeding Unit).

FIG. 25 is a view similar to FIG. 24 showing unit A in a different configuration.

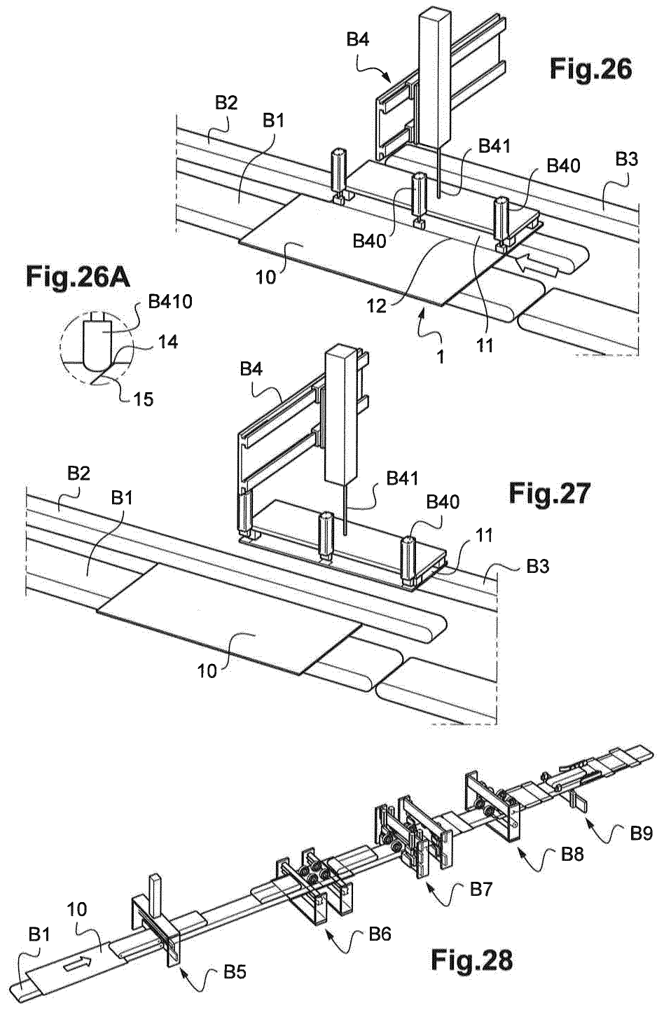

FIGS. 26 and 27 are perspective views of the splitting device of unit B (Transformation Unit).

FIG. 26A is an enlarged view of FIG. 26.

FIG. 28 is a perspective view of the first body transformation line of unit B (Transformation Unit).

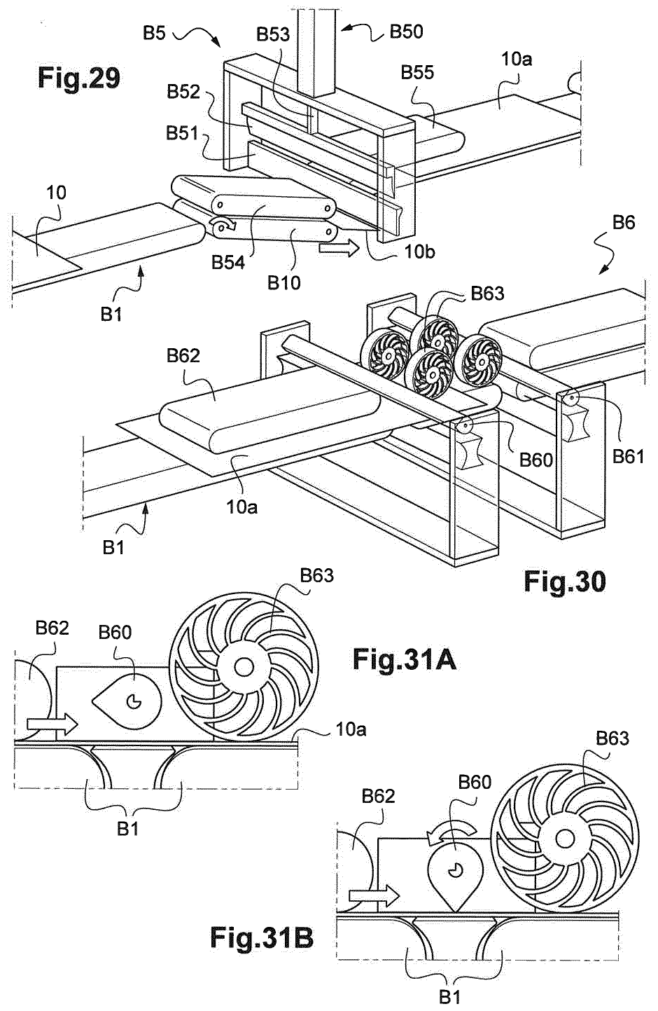

FIG. 29 is an enlarged view of the cutting device illustrated in FIG. 28 during its functioning.

FIG. 30 is an enlarged view of the means for creating the first fold lines illustrated in FIG. 28.

FIGS. 31A and 31B are side views of the means illustrated in FIG. 30 during their functioning.

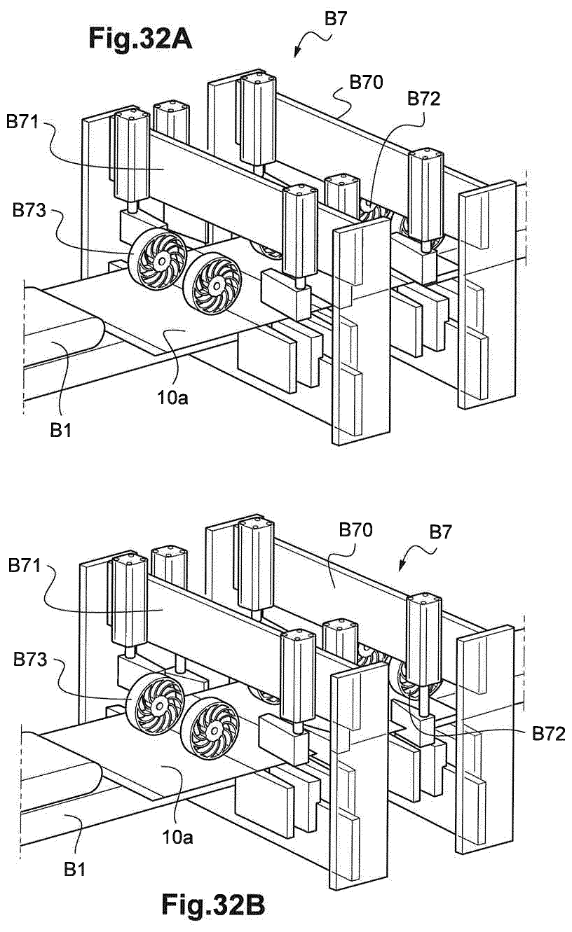

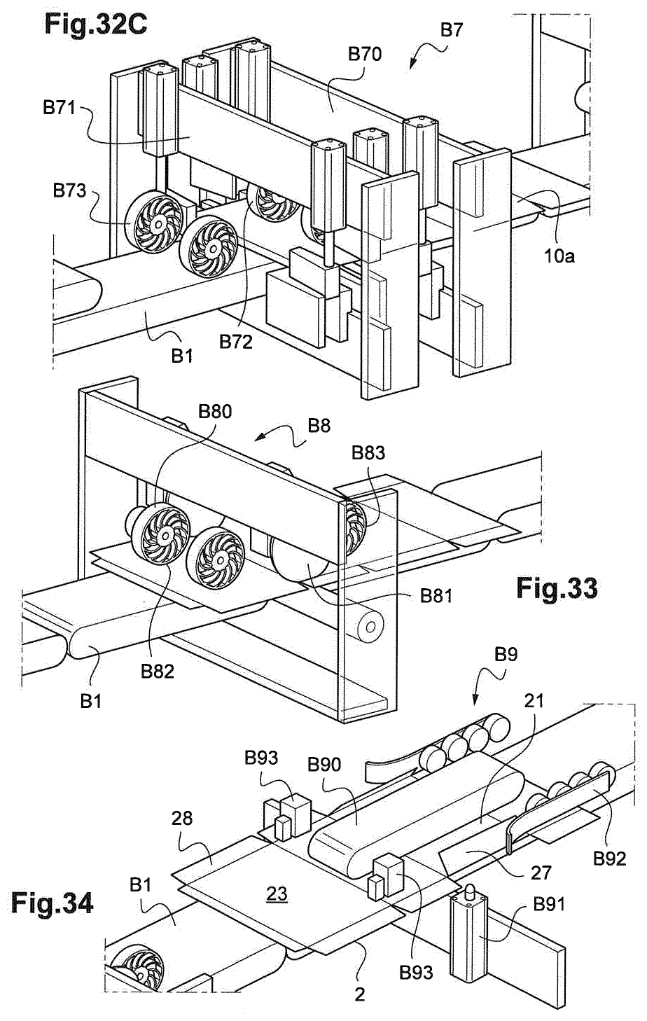

FIGS. 32A and 32C are perspective views of the slots cutting device illustrated in FIG. 28 during its functioning.

FIG. 33 is an enlarged view of the means for creating the second fold lines illustrated in FIG. 28.

FIG. 34 is an enlarged view of the folding means illustrated in FIG. 28.

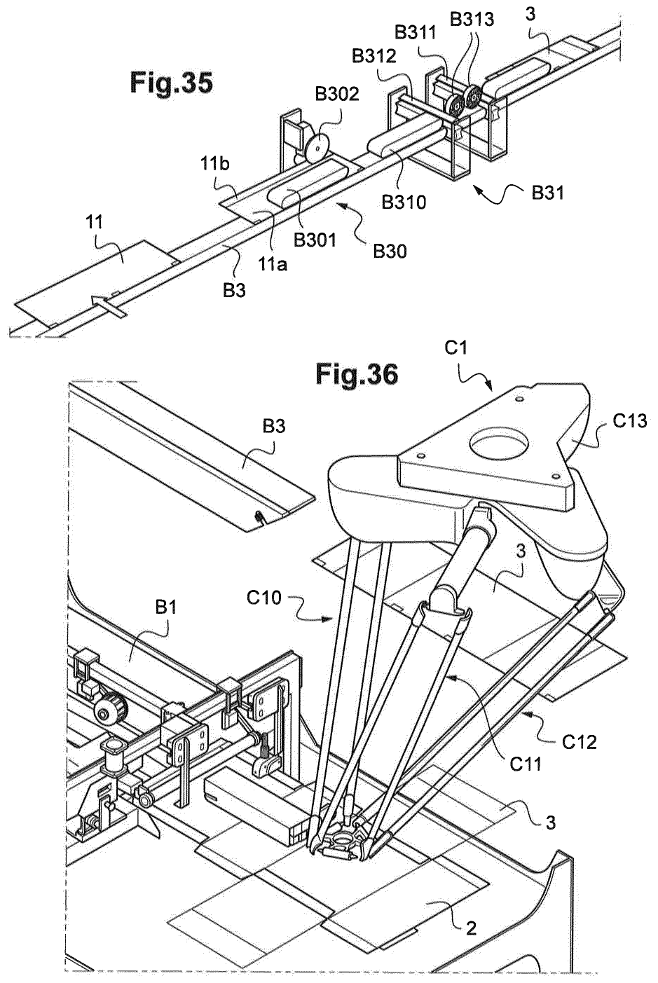

FIG. 35 is a perspective view of the second body transformation line of unit B (Transformation Unit).

FIG. 36 is a perspective view of the means for assembling the first and the second bodies of unit C (Assembly and box forming Unit).

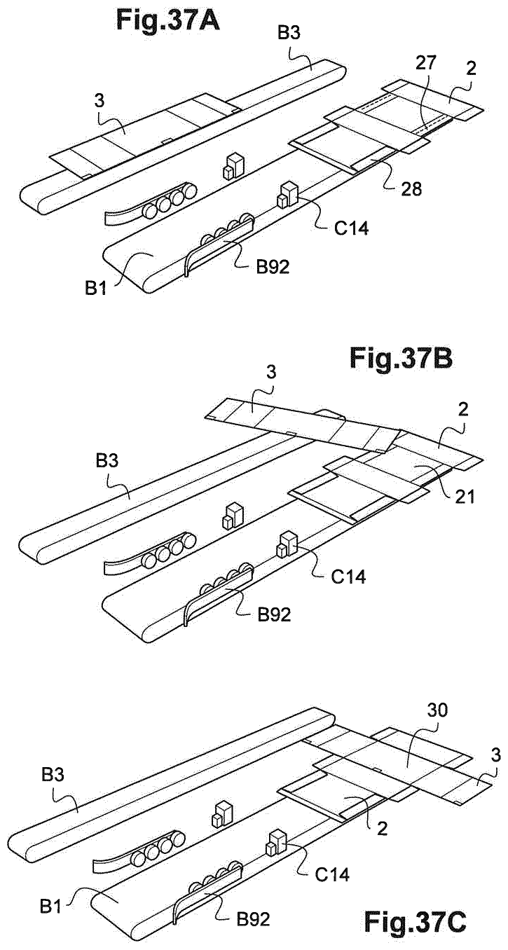

FIGS. 37A to 37C are schematic perspective views illustrating the functioning of the assembly means illustrated in FIG. 36.

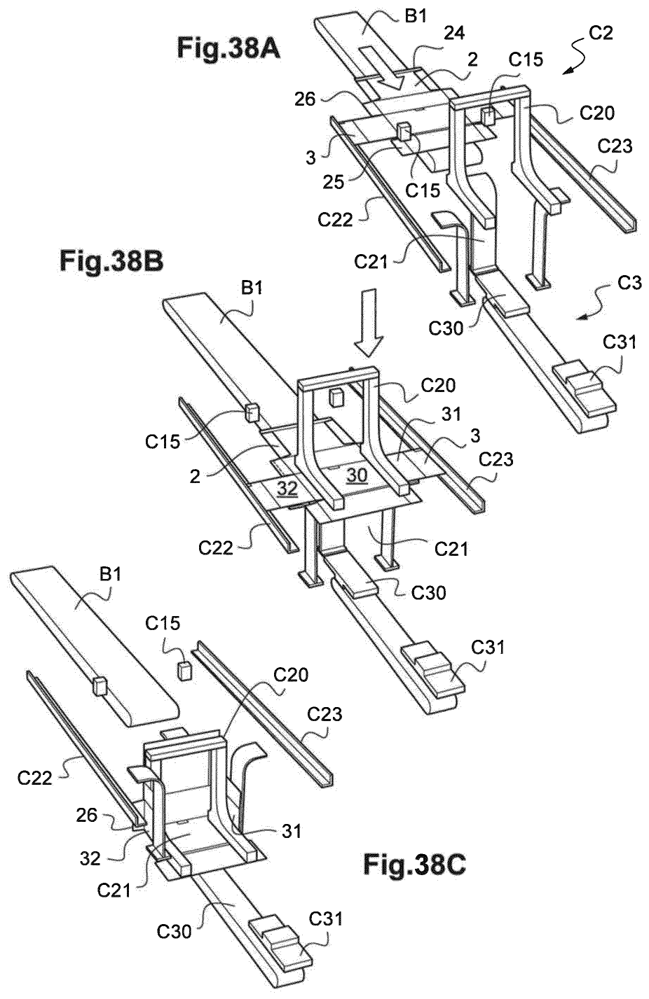

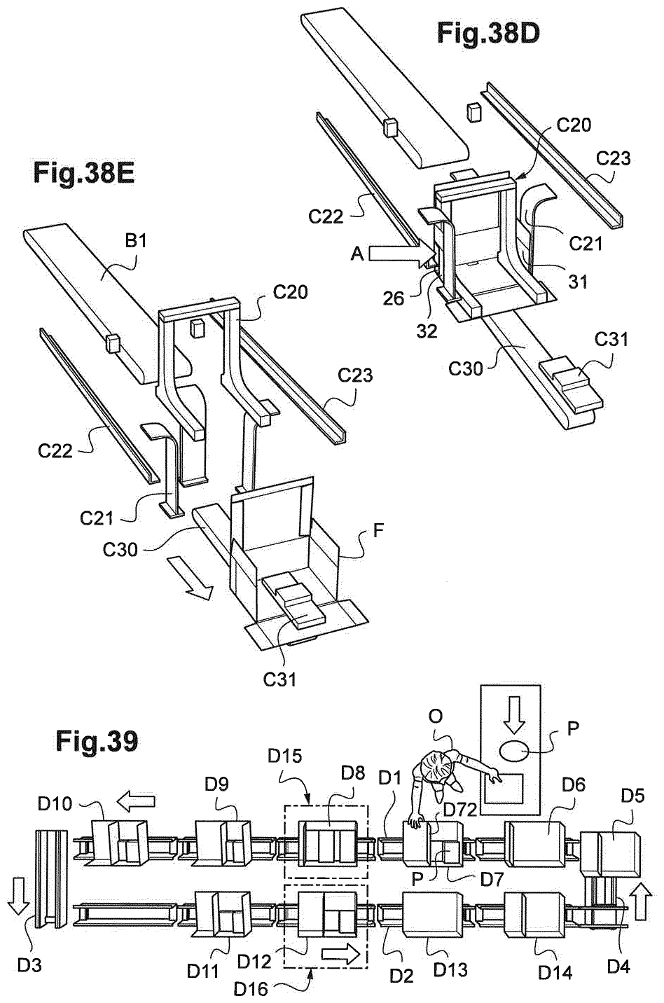

FIGS. 38A to 38E are perspective view of the device for box forming and transfer, illustrating its functioning (Unit C).

FIG. 39 is a top view of unit D (Order preparation Unit) showing different configurations of a crate for preparing products.

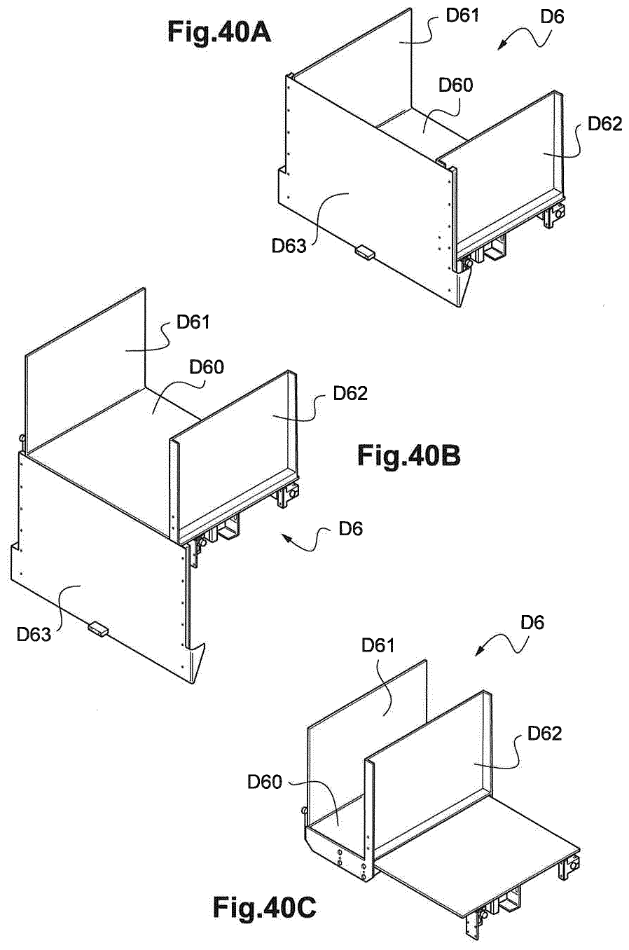

FIGS. 40A to 40C are perspective views illustrating the crate used in unit D.

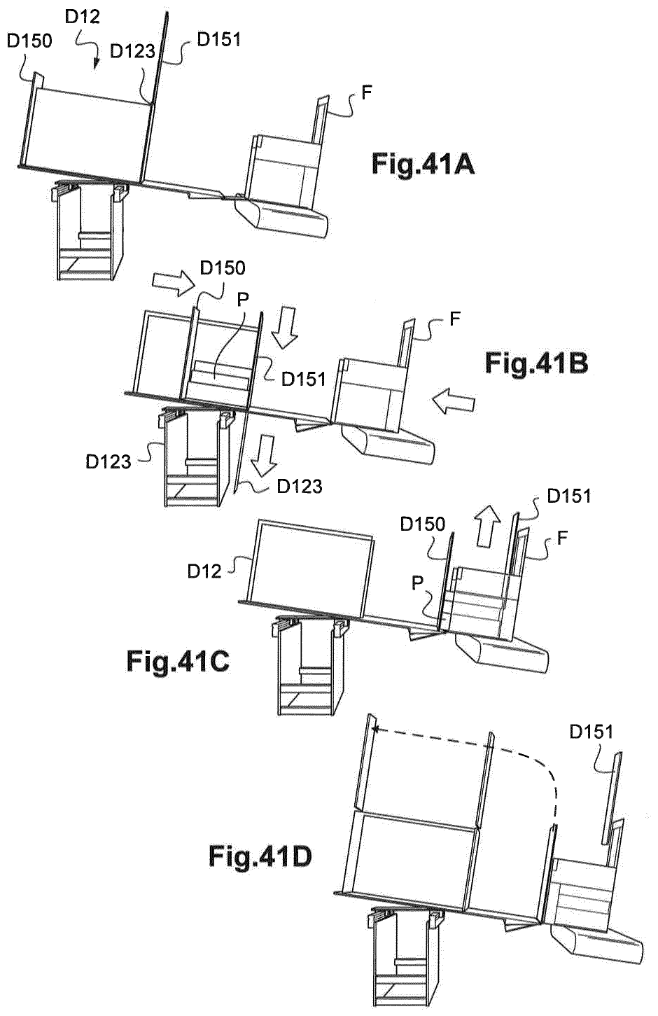

FIGS. 41A to 41D are lateral views of the crate illustrated in FIGS. 40A to 40C illustrating the filling step (Units D and E).

FIG. 1 shows a blank 1 according to a first embodiment of the invention which comprises a first body 10 and a second body 11 which are both of rectangular shape and which are linked together by a separation line 12.

The first body and the second body have different widths (D1, d1) and lengths (D2, d2) which will be described later. At this stage, it can be pointed out that these widths and lengths are adapted to the size of the final box in order to reduce waste material.

Moreover, since the bodies have different lengths, the part of the blank corresponding to the difference between both lengths has been already removed. This removal also reduces waste material during the manufacture of the box.

This blank 1 and these bodies 10 and 11 are obtained from a sheet of corrugated cardboard material which fits in a rectangle.

The separation line 12 comprises alternate portions of cut 12a and portions of perforations 12b.

Moreover, the second body 11 includes tabs 15, three tabs are illustrated in the embodiment of FIG. 1.

As shown in FIG. 1A, each of these tabs is defined by a portion of perforations 12b and two cuts 13 which connect the portion of perforations 12b to a fold line 14 parallel to the portion 12b.

These cuts 13 are parallel to each other and perpendicular to the separation line 12 and to the fold line 14.

The invention is not limited to the embodiment illustrated in FIG. 1. The tabs 15 could be for instance provided in the first body 10 and the number of tabs 15 could be different.

From this blank 1, can be formed two belts from which a box having a polygonal cross section will be obtained.

The blank has been chosen among a predetermined number of different blanks having different dimensions, depending on the size of the products to be packed in a box according to the invention.

It is taken with suction pads from a stack of blanks and transferred on a conveyor which is linearly driven through a transformation unit.

In all the specification, a conveyor used to transfer a blank, a belt or a box can be a vacuum conveyor or any other means such as two conveyors, one placed on top of the other, or a system including at least one arm with suction pads.

In order to make a choice between the different blanks which are available, the products are assembled to form the most compact assembly or stack and the stack is measured. In case a single item has to be packed, it is directly measured.

Measuring means including for instance a laser means are used to determine the largest length, width and height of the single item or of the stacked products.

These measures enable to determine the length L, the width W and the height H of the box able to house the product(s) with the highest filling rate.

At this stage, it must be pointed out that the dimensions of the box can be freely chosen and the available blanks are chosen to meet all the possible combinations of products intended to be packed and sent to a final client.

FIG. 2 shows the first step of the method of manufacturing a set of a first belt and a second belt from the blank 1 illustrated in FIG. 1.

This first step is carried out in a station of the transformation unit including a splitting device by means of which, the blank 1 is separated in two parts by punching the tabs 15 in order to break the portions of perforations 12b.

The invention is of course not limited to this embodiment and the blank could be a one piece blank, the first body and the second body being in that case separated by means of a rotary cutter.

After this step, the first body 10 and the second body 12 are separated. The first body 10 stays in place and the second body 11 is transferred in a direction shown by the arrow D by suction pads, so that the first and the second bodies are parallel to each other and positioned on parallel and spaced apart conveyors.

The first and second belts which will be obtained from the first and second bodies 10 and 11 are intended to form a box having the length L, the width W and the height H previously determined by the size measurement of the product(s) to be packed (see FIGS. 9D and 21B).

All dimensions given in this specification refer to internal dimensions of the box.

The first body 10 has a first dimension D1 (width) larger than the length L and a second dimension D2 (length) larger than twice the width W plus the height H (2W+2H).

The second body 11 has a first dimension d1 (width) larger than the width W and a second dimension d2 (length) larger than the length L plus twice the height H of the final box (2H+L). Roughly speaking, the first body 10 has dimensions D1 and D2 large enough to create the length L and the height H of the box, while the second body 11 has dimensions d1 and d2 large enough to create the width W and the height H of the box.

The choice between the predetermined number of different blanks is made in order that the chosen blank has the dimensions closest to the ones of the final box to reduce the waste.

FIG. 2 shows that the first and second bodies are sharp-edged components which are supplied without any fold line.

Each of the bodies 10 and 11 is transferred by its conveyor (which is driven to have a linear motion) along a transformation line.

FIG. 3 shows another step during which the first body 10 is transferred to a position where it is cut to reduce its second dimension D2 and obtain a modified first body 10a having a second dimension D2′ which is equal to the sum of twice the width W plus the height H plus the width w of a flap which will be described later as third flap 24 (D2′=2W+2H+w).

In other words, the cutting the first body 10 reduces its length and creates waste 10b having a second dimension D2″ which is equal to D2−2(W+H)−w (D2″=D2−2 (W+H)−w).

It can be noticed that when the second dimension (length) D2 of the first body is less than twice the width W of the box plus three times the height H of the box, it is not necessary to reduce it. Indeed, in such a case, the width w of the third flap is less than the height H of the box and the third flap 24 can be therefore glued on the small panel 20 in order to close the box as explained later.

The second body is in parallel cut during its transfer on its conveyor so as to reduce its first dimension d1 (width).

The first dimension d1′ of the modified second body 11a is equal to the width W of the box (d1=W).

In other words, cutting this second body reduces its width and creates waste 11b which has a first dimension d1″ equal to d1−W (d1″=W−d1).

The invention is not limited to this process and the width (D1) of the first body 10 and/or the length (d2) of the second body 11 could also be modified. However, with this structure, overwidth of the first body or overlength of the second body can be accepted.

The first and second modified bodies 10a and 11a are still transferred along their own conveyor and, during this transfer, first fold lines 16, 18 are made in each body by using a specific rotary system. The first fold lines 16 define four main rectangular panels 20 to 23 and a third flap 24 connected to the main panel 23, in the body 10a while the first fold lines 18 define a central panel 30, two secondary panels 31, 32 and two flaps 33, 34, in the body 11a.

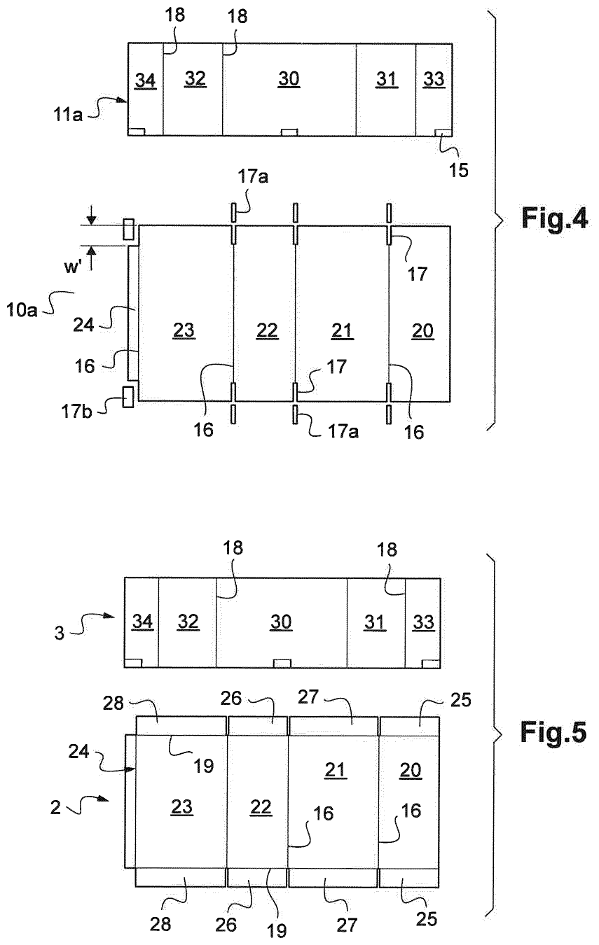

FIG. 4 illustrates a further step of the method according to the invention during which the modified first body 10a is cut in line with the fold lines 16, along a pre-determined distance equal to the width w′ and on both sides, to create slots 17.

These cuts create waste portions 17a.

The modified first body 10a is then cut at the two free ends of the third flap 24.

This cut creates two waste portions 17b.

All these cuts are made by cutting means which are moved perpendicularly with regard to the plane defined by the first body.

FIG. 5 illustrates the last step of the method of manufacturing a first belt and a second belt from the blank 1 of FIG. 1, according to the invention.

While the modified first and second bodies are linearly moved on their own conveyor, second fold lines 19 are created in the first modified body 10a.

Each of these second fold lines 19 is spaced from a free edge of the first body 10a from a distance equal to the width w′. Both second fold lines 19 are parallel to each other, perpendicular to the first fold line 16 and spaced apart from the length L of the final box.

FIG. 5 shows the first belt 2 and the second belt 3 obtained at the end of the previously described steps.

The first belt 2 comprises four main rectangular panels 20 to 23. They all have the same length which is equal to the length L of the box but they have different widths. The width of the panels 20 and 22 (small panels) is equal to the height H of the box while the width of the panels 21 and 23 (large panels) is equal to the width W of the box.

A pair of first flaps 25, 26 is provided on the opposing sides of the small main panels 20 and 22 and a pair of second flaps 27, 28 is provided on the opposing sides of each of the large main panels 21 and 23. The width of these first and second flaps is equal to w′.

The second belt 3 comprises the central panel 30 which is provided on each side with a secondary panel 31, 32, each of them being connected to a flap 33, 34.

The central panel 30 of the second belt and the main large panel 21 of the first belt are identical.

The invention is not limited to this embodiment and the flaps 33, 34 could be for instance omitted.

Reference is now made to FIGS. 7 and 8 to describe how a box can be partially erected by using the first belt 2 and the second belt 3 illustrated in FIG. 5.

After their formation, the first belt 2 and the second belt 3 are transferred to an assembly station.

During that transfer, the second flaps 27, 28 of the first body are coated with glue and each pair of second flaps 27, 28 are folded and glued respectively on a large main panel 21, 23.

These second flaps will strengthen the final box. At the assembly and forming unit, the second flaps are coated with glue and the second belt 3 is taken by suction pads, then rotated 90°, positioned on the first belt 2 so that the central panel 30 of the second belt matches the large main panel 21 of the first belt 2.

FIG. 7 shows that when both belts 2 and 3 are joined, the first fold lines 16 of the first belt 2 are perpendicular to the first fold line 18 of the second belt 3, the resulting blank being cross-shaped.

The joined belts 2 and 3 are then transferred to the forming position where the box is partially erected and during the transfer, glue is applied on appropriate parts of the belts (at least on the first flaps 26). The forming unit is provided with a forming device which is based on a classic tray shaping principle using a forming cavity.

At the forming unit, each of the secondary panels 31 and 32 of the second belt 3 is folded along a first fold line 18, then the small main panel 22 of the first belt 2 is folded along a first fold line 16 and finally, the first flaps 26 are glued on the outer face of the secondary panels 31 and 32.

FIG. 8 shows that the large main panel 21 of the first belt 2 will form, with the central panel 30 of the second belt, the bottom of the box, while the other large main panel 23 of the first belt will form the top of the box.

Moreover, the small main panels 22, 20 of the first belt 2 will form the first and second lateral walls of the box.

After having been partially erected, the box is laterally ejected from the forming cavity by means of an ejection device using vacuum and suction pads. The box as shown in FIG. 8, is then transferred to the filling station.

The products P which have been previously measured are loaded in the box through the side of the box facing the first lateral wall 22 and which is still open (FIG. 9A).

In the next step, the small main panel 20 is folded along a first fold line 16 and the first flaps 25 are glued on the outer face of the secondary panels 31, 32, forming the third and fourth lateral walls of the box (FIG. 9B).

During the next step illustrated in FIG. 9C, the flaps 33, 34 of the second belt 3 are folded toward the interior of the box along a first fold line 18 and then coated with glue.

FIG. 9D illustrates the last steps during which the large main panel 23 is folded toward the interior of the box along a first fold line 16.

The third flap 24, coated with glue, is folded along a fold line 16 and then pressed against the small main panel 20 in order to close the box.

The box is then transferred to an external conveyor.

FIG. 6 illustrates a variant of the step illustrated in FIG. 5.

With this variant, the blank 1 undergoes the steps illustrated in FIGS. 2 to 4 and at the end of the linear transfer, while the second fold lines 19 are created in the modified first body 10a, an intermediate fold line 19a is created on each side of the modified first body 10a, between a second fold line 19 and a free edge of the modified first body 10a.

The different parts of the corresponding first belt 4 are designated by the same references than the ones used for belt 2, instead that all references of the 2× type become 4×.

Therefore, each of the first and second flaps 45, 46 and 47, 48 is provided with an intermediate fold line 19a, each intermediate fold line 19a defining an intermediate flap 45a, 46a and 47a, 48a with the adjacent second fold line 19.

It must be pointed out that the central panel 30 and the large main panel 41 have the same width (W) but the length of the central panel is equal to the length (L) of the main panel 41 minus twice the width of an intermediate flap 47a.

FIG. 10 shows a first step of forming a box with the first belt 4 and second belt 3 illustrated on FIG. 6.

The second flaps 47, 48, together with the corresponding intermediate flaps 47a, 48a previously coated with glue, are folded along the second fold lines 19 and glued to the large main panel 41 and 43.

These second flaps will strengthen the box.

Then, at the assembly unit, the second flaps 47 are coated with glue and the second belt 3 is taken by section pads, rotated 90°, and placed on the first body 4 so that the central panel 30 of the second belt 3 is centered within the large main panel 41, the first belt 4 and the second belt 3 being joined in the position illustrated in FIG. 10.

The joined bodies are then coated with glue during their transfer to the forming station and the box is partially erected as illustrated in FIG. 11A.

FIG. 11A shows that the intermediate flaps 46a are folded along the fold line 19 and glued to the small main panel 42.

The first flaps 46 are folded along an intermediate fold line 19a and the small main panel 42 is folded along the first fold line 16 while the secondary panels 31, 32 of the second belt 3 are folded along the first fold lines 18.

The first flaps 46 are then glued on the secondary panels 31, 32 to obtain the box illustrated in FIG. 11A which is then transferred to the filling station.

The products P previously measured are loaded in the box through the side of the box facing the first lateral wall 42 and which is still open.

The intermediate flaps 45a are then glued on the small main panel 40 which is folded along a first fold line 16 and the first flaps 45 are folded along an intermediate fold line 45a and glued on the outer face of the secondary panels 31, 32, forming the third and fourth lateral walls of the box.

The flaps 33, 34 of the second belt 3 are folded toward the interior of the box along a first fold line 18 and then coated with glue.

The box obtained at the end of these steps is illustrated in FIG. 11B.

FIG. 11C illustrates the last steps during which the large main panel 23 is folded toward the interior of the box along a first fold line 16.

The third flap 44, coated with glue, is folded along a fold line 16 and then pressed against the small main panel 40 in order to close the box which is then transferred to an external conveyor.

FIG. 11C shows that the box according to this variant of the first embodiment is provided with shock absorbers (buffers).

A second embodiment of the invention will now be described in reference to FIGS. 12 to 22.

FIG. 12 shows a blank 5 according to a second embodiment of the invention which comprises a first body 50 and a second body 51 which are both of rectangular shape and which are linked together by a separation line 52.

As explained for the first embodiment, the first body and the second body have different widths (D1, d1) and lengths (D2, d2). At this stage, it can be pointed out that these widths and lengths are adapted to the size of the final box in order to reduce waste material.

This blank 5 is obtained from a sheet of corrugated cardboard material which fits in a rectangle.

Since the bodies have different lengths, the part of the blank corresponding to the difference between both lengths has been already removed. This removal also reduces waste material during the manufacture of the box.

As explained with regard to FIG. 1, this separation line 52 comprises alternate portions of cut 52a and portions of perforations 52b which define tabs 55 in cooperation with cuts 53 and fold lines 54.

This separation line 52 is similar to separation line 12 and will not be described in detail again.

As explained previously, this blank 5 has been chosen among a predetermined number of different blanks, in accordance with the size of the product(s) to be packed.

FIG. 13 shows the first step of the method of forming a set of a first belt and a second belt from the blank 5 illustrated in FIG. 12, these belts being further used for forming a box designed for packaging the product(s) in question.

In this first step, the blank 5 is separated in two parts by punching the tabs 55 in order to break the portions of perforations 52b.

As explained previously, the invention is not limited to this embodiment and the second blank could be a one piece blank, the bodies 50 and 51 being separated by means of a rotary device.

The first body 50 has a first dimension (width) D1 larger than the length L of the box and a second dimension (length) D2 larger than the height H plus twice the width W (2W+H).

The second body 51 has a first dimension (width) d1 larger than the height H of the box and a second dimension (length) d2 larger than the length L plus twice the width W (2W+L).

As described for blank 1, the first body 50 has dimensions D1 and D2 large enough to create the length L and the height H of the box, while the second body 51 has dimensions d1 and d2 large enough to create the width W and the height H of the box.

It is thus understood that blank 5 is chosen among the different available blanks because its dimensions are the closest to the ones of the box to be obtained, in order to reduce the waste.

After separation in two parts of the blank 5, the first body 50 stays in place and the second body 51 is transferred in a direction D parallel to the first dimension D1 so that the first and second bodies are positioned on two conveyors parallel to each other and spaced apart.

FIG. 14 shows another step during which the first body 50 and the second body 51 are transferred, each on its conveyor having a linear motion, along a transformation line where they are cut to reduce their length (second dimension D2, d2).

It is thus obtained a modified first body 50a having a second dimension D2′ which is equal to the height H plus twice the width W plus the width w of two flaps (third and fourth flaps) which will be described later (D2′=2W+H+2w).

In other words, cutting the first body 50 reduces its length and create a waste 50b having a second dimension D2″ which is equal to the difference between D2 on the one hand and twice the width W of the box plus the height plus twice the width w of the flaps (D2″=D2−2W−H−2w).

Similarly, is obtained a modified second body 51a having a second dimension d2′ which is equal the length L and twice the width W of the box (d2′=L+2W).

Waste 51b thus created by the cutting has a second dimension d2″ which is the difference between d2 on one hand and the sum of the length L plus twice the height H on the other hand (d″2=d2−L−2H).

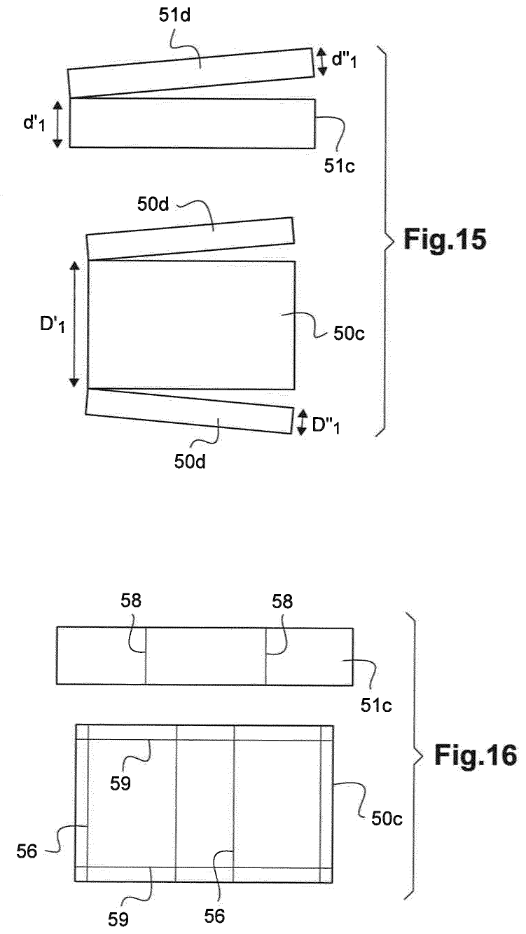

FIG. 15 illustrates another step during which the modified first and second bodies are still transferred along the transformation line where they are cut to reduce their first dimension or in other words their width.

Concerning the modified first body 50c, it has a first dimension D1′ which is equal to the length L of the box and twice the width w′ of first and second flaps which will be described later (D1′=L+2w′).

Waste 50d created by this cutting have each a first dimension D1″, twice D1″ being equal to the difference between D1 on the one hand and the length L and twice the width w′ on the other hand (2D1″=D1−L−2w′).

Concerning the modified second body 51c, its first dimension d1′ is equal to the height H of the box (d1=H).

Waste 51d has thus a first dimension d1″ which is equal to the difference between d1 and the height H of the box (d1″=d1−H).

The modified first and second bodies 50c and 51c are then transferred along the conveyor and, during this transfer, first folding lines 56, 58 are made in each body and second fold lines 59 perpendicular to the first fold lines 56 are created in the modified first body 50c, by using specific rotary systems and linear devices.

The second fold lines 59 are spaced apart from the length L of the final box.

FIG. 17 shows the last step of the manufacture of a first belt 6 and a second belt 7 using the blank 5 illustrated in FIG. 12.

During that step, the modified first body 50c is cut on two opposing sides, from its free edge to one of the second fold line 59 and along each first fold line 56.

These cuts create waste portions 50e and 50d.

FIG. 17 shows the first belt 6 and the second belt 7 obtained at the end of the previously described steps.

The first belt 6 comprises three main rectangular panels 60 to 62 connected to each other by a first fold line 16. They all have the same length which is equal to the length L of the box but they have different widths.

The width of the panel 60 and 62 (large panels) is equal to the width W of the box while the width of the panel 61 (small panel) is equal to the height H of the box.

A pair of first flaps 65, 66 is provided on the opposing sides of the large main panel 60 and of the small main panel 61 and a pair of second flaps 67 is provided on the opposing sides of the large main panel 62.

Each of these first and second flaps are connected to the corresponding main panel by means of a second fold line 59 and has a width w′.

Moreover, the large main panel 62 is connected to a third flap 64 by means of a first fold line 56 while the other large main panel 60 is connected to a fourth flap 63 by means of another first fold line 56, each of these flaps having a width w.

The second belt 7 comprises a central panel 70 which is provided on each side with a secondary panel 71, 72.

Reference is now made to FIGS. 19 and 20 to describe how a box can be erected by using the first belt 6 and the second belt 7 illustrated in FIG. 17.

After their manufacture, the first belt 6 and the second belt 7 are transferred to an assembly unit.

During that transfer, the fourth flap 63 is coated with glue.

At the assembly unit, the second belt 7 is taken by suction pads, then rotated 90° and positioned on the first belt 6 so that the central panel 70 of the second belt 7 covers the fourth flap 63 of the first belt 6.

FIG. 19 shows that when the belts are joined, the first fold lines 56 of the first belt 6 are perpendicular to the first fold lines 58 of the second belt 7, the resulting blank being T-shaped.

The joined belts 6 and 7 are then transferred to the forming unit where the box is erected and, during the transfer, glue is applied on appropriate parts of the belts.

At the forming station, each of the secondary panels 71 and 72 of the second belt 7 is folded along a first fold line 58 and the central panel 70 is folded along a first fold line 56, all of them toward the interior of the box, then the small main panel 61 of the first belt 6 is folded along a first fold line 56 and finally, the first flaps 65 and 66 are glued on the outer face of the secondary panels 71 and 72.

FIG. 20 shows that the main large panel 60 of the first belt 6 will form the bottom of the box, while the other large main panel 62 of the first belt 6 will form the top of the box.

Moreover, the small main panel 61 of the first belt 6 and the central panel 70 of the second belt 7 will form the first and second lateral walls of the box, while the secondary panels 71, 72 of the second belt 7 will form the third and fourth lateral walls of the box.

The box illustrated in FIG. 20 is then transferred to the filling station.

FIG. 21A shows the products P loaded in the box through its top opening.

During the next step, the large main panel 62 is folded toward the interior of the box along a first fold line 56 until it closes the opening. Each of the secondary flaps 67 is then folded along a second fold line 59 and the third flap 64 is folded along a first fold line 56, all these flaps being then pressed against the secondary panel 71 and 72 and the central panel 70 of the second belt 7, in order to close the box (FIG. 21B).

The box is then transferred to an external conveyor.

FIG. 18 illustrates a variant of the steps according to FIGS. 16 and 17 for the manufacture of a first belt 8 and a second belt 9.

The different parts of the first belt 8, respectively the second belt 9 are designated by the same references than the ones used for the first belt 6, respectively the second belt 7, instead that all references of the 6× type, respectively of the 7× type become 8×, respectively 9X.

According to this variant, during the step illustrated in FIG. 16, intermediate fold lines 59a are formed in the first modified body 50c, each of them extending between the free edge of the body 50c and a second fold line 59.

Intermediate flaps 85a, 86a and 87a are formed between a second fold line 59 and an intermediate fold line 59a.

The width of each of the intermediate flaps is equal to the distance between the second fold line 59 and an adjacent intermediate fold line 59a.

Similarly, intermediate fold lines 58a are formed, parallel to a first fold line 58, two adjacent fold lines 58 and 58a defining an intermediate panel 91a, 92a which has the same width than the intermediate panels defined in the first belt.

FIG. 18 shows a first belt 8 and a second belt 9 according to the variant of the second embodiment according to the invention.

The final box illustrated in FIG. 22 is obtained as follows.

The second belt 9 is glued to the first belt 8 by means of the fourth flap 83, previously coated with glue, and the central panel 90.

The joined bodies are coated with glue during their transfer to the forming unit and the box is erected as follows.

The intermediate flaps 86a are glued on the corresponding main panel 81 and the intermediate panels 91a and 92a are glued on the central panel 90.

The flaps 85, 87 together with their intermediate panels 85a, 87a are glued on the corresponding main panel 80, 82.

The central panel 90 and the small main panel 81 are folded along their respective fold lines and the first flaps 86 are glued on the secondary panels 91 and 92 of the second belt 9.

The box is then filled with the product(s) to which it is intended and then closed by folding the large main panel 82 along a first fold line 56 and by gluing the flap 84 on the central panel 90 of the second belt.

It can be deduced from FIGS. 9D, 11C, 21B and 22 that a box according to the invention can be opened by the final client by tearing off the third flap, and where appropriate (FIG. 21B), the second flaps.

After its opening, the lateral walls of the box are still erected, contrary to the packaging of the prior art and the box can be thus reused.

Suitable means can be provided on these flaps to avoid their deterioration during the opening of the box so that it can be easily reused by the final client.

It can be further noticed that even if a panel of the first belt and a panel of the second belt are overlaid, the amount of material necessary to manufacture a box by the method according to the invention is reduced with regard to the known methods.

Some known methods to create such a box are based on a single rectangular blank further cut to obtain a cross or a T shape. For the cross shape, the transformation of a rectangular blank generates four pieces of waste material and two pieces of waste material are generated by the T shape. With the method according to the invention, transforming a rectangular blank into a first body and a second body linked together by a separation line limits the waste to a single piece which has a size defined by (D2−d2)*d1.

For instance, with a 240×160×100 mm box, the method according to the invention enables to save about 40% of waste material compared to these known methods.

Moreover, this single piece is removed before the blank is cut to manufacture a box.

Some know methods are based on the supply of only one cardboard in a continuous strip called fan-fold or Z-fold. Therefore, a cardboard presenting a single width is available per machine.

The width of the cardboard is used to create the length L and the height H of the final box (i.e. the width is larger than the length plus twice the height H). The machine cuts the cardboard along its length so that the length L of the cardboard corresponds to twice the width W and the height H of the box (2W+2H).

Since the width of the cardboard is constant, the amount of waste material increases continuously when the length L and the height H of the final box decrease.

To the contrary, with the invention, a choice can be made between different types of blank to create a box adapted to the size of the product(s) to be packed.

For instance, with a 240×160×100 mm box, the waste generated with a blank chosen according to the invention is of about 10% of the blank when with a blank cut in a continuous strip, the generated waste corresponds to more than 32% of the blank.

Reference will now be made to FIGS. 23 to 41D in order to describe an example of a machine according to the invention which enables the manufacture of a box sized to define a housing space for products which perfectly fits the size of these products.

FIG. 23 shows an overview of this machine which comprises five units:
Unit A is a storage and feeding unit which includes three stacks of blanks, each stack corresponding to one type of blank.

Unit A will be further described in reference to FIGS. 24 and 25.
Unit B is a transformation unit in which a blank is transformed into two belts. It will be described in reference to FIGS. 26 to 35.
Unit C is an assembly and box forming unit which will be described in reference to FIGS. 36 to 38E.
Unit D is an order preparation unit which will be described in reference to FIGS. 39 to 41D.
Unit E is a box filling and closing unit.

The general functioning of the machine is as follows:
Once a customer has sent an order for products, this order is prepared and an operator puts the products in a metallic crate, each crate is labelled with a barcode or an RFID tag.

The management system of the machine links the customer's order to the crate label (Unit D).
The crate is then transferred to a filling position and during this transfer, the products are measured to determine the size of the RSP box (Unit D). In other words, the length L, the width W and the height H of the box are chosen so that the box is closely adapted to the size of the products to be packed.
On the basis of this determined box size, a blank is chosen and picked up from one of the three types of blank (T1, T2 or T3) which are stored in Unit A and transferred to Unit B. During this stage, a barcode may be inscribed by laser or print on the blank, in order to link the customer's order to the chosen blank.

Therefore, the customer's order is linked to a crate housing the products corresponding to the order and to the RSP box which will be created from the chosen blank, by means of barcodes.
The chosen blank is then transformed in Unit B in order to create two belts which are then assembled in Unit C.
After their assembly, the RSP box is partially erected (Unit C) and transferred to the filling Unit E.

The filled box is then closed and transferred to a shipment unit (Unit E).

The functioning is described in relation with an order for several products, but it is identical if the order includes only one product.

The following description is made for a blank of the type illustrated in FIG. 1, which leads to belts which are joined in order to be cross-shaped. However, the machine could be easily adapted to create belts and to form a box with a blank of the type illustrated in FIG. 12.

Unit A will be now further described in reference to FIGS. 24 and 25.

Unit A mainly comprises three movable pallets A1 to A3, an extraction device A4 and a transfer device

A5.

Each of the movable pallets A1 to A3 includes a support A10 to A30 which is supported by elevator means A11 to A31.

On each pallets, are stacked blanks of the same type.

For illustration purposes only, the three types of blank are defined to be able to obtain boxes having:
a length L ranging from 180 mm to 455 mm,
a width W ranging from 140 mm to 340 mm and
a height H ranging from 25 mm to 265 mm.

Any box having a size within these three ranges can be obtained from a blank chosen among three different types T1, T2 and T3, defined in the following table.

| | D1 | D2 | d1 | d2 |
|---|---|---|---|---|
| | (mm) | (mm) | (mm) | (mm) |
| T1 | 370 | 574 | 230 | 500 |
| T2 | 400 | 870 | 260 | 740 |
| T3 | 555 | 1200 | 350 | 1100 |

The blanks of the T1 type (and of the T2 type) are stacked in one pile on a 800×1200 pallet.

Blanks T3 are also stacked in one pile but on a 1000×1200 pallet.

The height of all the corresponding stacks A12 to A32 is of 1800 mm.

FIG. 24 represents the Unit A at the beginning of the functioning of the machine. Therefore, the three stacks A12 to A32 have the same height.

The extraction device A4 includes an extraction arm A40 which extends almost vertically, i.e. almost perpendicular to the plane of the pallets A11 to A31.

This extraction arm is providing with handling means A400 at its free end which support suction pads A401.

This arm is movable along its own (vertical) axis and also along a horizontal support A41 which is perpendicular to its axis.

As explained previously, once the ordered products are measured and the size of the RSP box is defined, a blank is chosen among the three types of blank T1 to T3.

A software can be used to determine from the size of the RSP box (L, W, H), the size of the first and second belts and from the latter, which type of blank is adapted to said box.

In the example illustrated in FIG. 24, a blank T2 is chosen, therefore, the extraction arm A40 is positioned above the stack A22.

The arm A40 will be then operated to move downwards so that the suction pads A401 come into contact with the highest blank in the stack and take it.

The arm A40 is then operated to deposit the blank T2 on the transfer device A5.

FIG. 25 illustrates Unit A at a further stage of the functioning of the machine where the arm A40 is positioned above the transfer device A5.

It is understood that after its deposition on the transfer device A5, a blank is transferred to Unit B.

FIG. 25 shows that each movable pallet A1 to A3 is controlled so that the top of each stack A12 to A32 remains at the same level after the removal of several blanks.

For that purpose, Unit A includes a laser cell which measures the position of the top of each stack and operates accordingly each elevator A11 to A31.

Reference is now made to FIGS. 26 and 27 which illustrate the splitting device B4 of Unit B.

On FIG. 26, are illustrated three conveyors B1, B2 and B3 which are parallel to each other.

The blank 1 taken from stack A22 is transferred from Unit A to Unit B by means of the conveyors B1 and B2 which are spaced apart.

As shown on FIG. 26, the separation line 12 of blank 1 (as illustrated in FIG. 1) is positioned between the conveyors B1 and B2.

In the position illustrated in FIG. 26, suction pads B40 are used to hold the blank 1 in position on conveyors B1 and B2.

The splitting device B4 is positioned above the blank 1 and is moved along the separation line 12 in order to punch the tabs 15 by means of its movable rod B41.

FIG. 26A shows the free end 410 of the rod while it goes through the blank, the tab 15 being folded along its fold line 14 and the portion of perforations 12b broken.

Once the first body 10 and the second body 11 are separated, the suction pads B40 transfer the second body 11 from the conveyor B2 to the conveyor B3, the resulting relative position of the first body 10 and the second body 11 is illustrated in FIG. 27.

The first body 10 will then go through the first body transformation line illustrated in FIG. 28, while the second body 11 will go through a second body transformation line illustrated in FIG. 35, the transformation of both bodies being made in parallel. The first body transformation line and the second body transformation line are part of Unit B.

FIG. 28 shows that the first body transformation line comprises five stations B5 to B9 through which the first body 10 is transferred by means of the conveyor B1.

The first body is in a first step cut in station B5 (first body length sizing) so that the length of the first body 10 (second dimension D2) is, after cutting, equal to twice the width W plus the height plus the width of the third flap (D2=2W+2H+w).

Station B5 is illustrated in FIG. 29. It comprises a cutting device B50 having two cutting parts: a stationary part B51 and a movable part B52 which is moved vertically by means of a supporting arm B53.

When the first body 10 enters the station B5, the cutting parts are spaced apart and the first body 10 goes through this space.

It is then held in position by means of pressure conveyors B54 and B55 and the movable cutting part B52 is moved downwards in order to cut the first body 10 (guillotine action).

FIG. 29 shows that, in this example, the first conveyor B1 includes a movable portion B10 which can rotate along an axis perpendicular to the conveyor B1 and is positioned in front of the cutting device B50.

Therefore, after the cutting of the first body 10, corresponding waste 10b is still held between the movable portion B10 and the pressure conveyor B54 and their combined rotation enables the outfeed of waste 10b.

In a second step, the modified first body 10a goes through station B6 (first fold lines creation) in which four fold lines are created along the width of the modified first body.

The station B6 includes two crease shafts B60 and B61 which are spaced apart and which enables the creation of the folding lines.

Station B6 also includes a pressure conveyor B62 located in front of the shaft B60 and, between shafts B60 and B61, four no-crush wheels B63.

The pressure conveyor B62 and the wheels B63 enable to hold the modified first body against the conveyor B1, during the creation of the first folding lines 16 (see FIG. 4), to control its position on the conveyor B1.

Reference is now made to FIGS. 31A and 31B which show two different steps of functioning of the station illustrated in FIG. 30.

FIG. 31A shows the modified first body 10a on the conveyor B1 during its positioning with regard to the crease shaft B60, by appropriate means including a laser cell.

Figure B31B shows a further step where the crease shaft B60 is rotated 90° in order to create a first fold line 16.

After creation of the fold line, the crease shaft is rotated to come back to the position illustrated in FIG. 31A.

Since the device B6 includes two crease shafts, it can create two fold lines very closed to one another.

FIGS. 32A to 32C illustrate the cutting device B7 which includes slot and flap cutting means B70 and B71, together with holding means B72 and B73 (no-crush wheels).

FIG. 32A shows the modified first body 10a which has been transferred by the conveyor B1 from station B6, the holding means B72 and B73 being pressed on the first modified body 10a to hold it in position while two pairs of slots 17 are cut, as shown in FIG. 32B.

As shown in FIG. 4, slots are cut in line with a first fold line 16.

FIG. 32C shows another step where another pair of slots 17 is created and the third flap 24 is also cut at its two free ends by means of the cutting means B71.

After this last cutting step, the modified first body is as shown in FIG. 4 and it is transferred by the conveyor B1 to the station B8 which will create the second fold lines 19 as illustrated in FIG. 5.

Reference is made to FIG. 33 which shows that the station B8 includes two motorized crease plates B80 and B81 which are spaced apart from the length L of the final box and two pairs of no-crush wheels B82 and B83 which maintain pressure on the first body to control its position on the conveyor B1.

At this end of this step, is obtained the first belt 2 illustrated in FIG. 5.

Reference is now made to FIG. 34 which illustrates the station B9 (flap folding).

FIG. 34 shows that the belt 2 is transferred to station B9 by the conveyor B1.

Station B9 comprises a pressure conveyor B90 and means B93 for coating with glue the second flaps 27, 28 of the belt 2, such as hot-melt guns.

Station B9 also comprises means B91 and B92 which are operated to fold each pair of second flaps 27, 28 on a large main panel 21, 23. To this end, the second flaps 27, 28 are folded at an angle 90° with means B91 while means B92 include guides and rollers for ending the folding of the flaps and pressing them on their respective main panel.

The belt 2 is then transferred by conveyor B1 to Unit C which will be described in reference to FIGS. 36 and 37A to 37C.

The second body transformation line of Unit B is illustrated in FIG. 35.

As previously explained with reference to FIG. 27, the second body 11 is, after separation from the first body 10, transferred on conveyor B3 along which are provided cutting means B30 and means B31 for creating first folding lines.

Cutting means B30 include a pressure conveyor B301 to hold the second body 11 against the conveyor B3 while it is cut by a rotary knife B302.

During this cutting step, the width (first dimension d1) of the second body is reduced and waste 11b is created, as previously explained in reference to FIG. 3.

The modified second body 11a is then transferred by the conveyor B3 to means B31 (first fold lines creation) which are similar to means B6 described with reference to FIG. 30.

Therefore, B31 includes a pressure conveyor 310, two crease shafts B311 and B312 and also no-crush wheels B313.

The functioning of means B31 is similar to the functioning of means B6 and will not be described again.

At the end of the second transformation line, is obtained the second belt 3, illustrated in FIG. 5.

Unit C will now be described in reference to FIGS. 36,37A to 37C and 38A to 38E.

This Unit C mainly includes a robot C1 illustrated in FIG. 36 and a forming device C2 illustrated in FIG. 38A.

The robot C1 is for instance a delta robot which has four degrees of freedom and three arms C10 to C12, each arm forming a parallelogram.

These arms are actuated by a motor C13.

FIGS. 37A to 37C will show how this robot C1 is operated.

FIG. 37A illustrates the first belt 2 on the conveyor B1 and the second belt 3 on the conveyor B3.

FIG. 37A also illustrates hot-melt guns (C14) used to coat the second flaps 27 of the first belt 2 with glue.

FIG. 37B illustrates the following step during which the robot C1 takes the second belt 3 from the conveyor B3, by means of suction pads, and rotates its 90°.

As shown in FIG. 37C, the second belt 3 is then positioned on the first belt so that the central panel 30 of the second belt matches the main panel 21 of the first belt 2 and pressure is applied on the central panel.

The joined belts illustrated on FIG. 7 are then obtained.

The forming means C2 are schematically illustrated on FIG. 38A, FIGS. 38B to 38E showing the different steps of functioning of the forming means C2.

FIG. 38A shows the joined belts 2 and 3 transferred by the conveyor B1 in order to enter the forming means C2. During that transfer, the first flaps 26 of the first belt 2 are coated with glue by means of the hot-melt guns C15.

The forming means C2 include a forming tool C20 which can move along a vertical axis (perpendicular to the plane of the conveyor B1), a cavity (C21) here defined by three elongated bodies, two guiding means C22 and C23, extending on each side of the cavity C21 and substantially parallel to the conveyor B1, and two folding and pressing means (not illustrated).

The forming Unit C also includes an ejection and transfer device C3 which comprises an ejection tool C30 and a transfer device C31.

FIGS. 38B and 38C show that when the central panel 30 of the second belt 3 is positioned under the forming tool C20, the latter is moved downwards and the belts are formed inside the cavity C21.

FIG. 38D shows that the folding and pressing means are then operated in order to fold the first flaps 26 of the first belt 2 (arrow A) and to glue them on the outer face of the secondary panels 31 and 32 of the second belt 3.

FIG. 38D shows the partially erected box F illustrated in FIG. 8.

FIG. 38E illustrates the last step where the forming tool C20 is moved upwards to be again in the position illustrated in FIG. 38A.

Finally, the partially erected box F is ejected from the cavity C21 by means of the ejection tool C30 using vacuum and suction pads.

The box F has shown in FIG. 8 is then transferred to Unit E by means of the transfer device C31 where the box will be filled with the product prepared in Unit D and then closed.

Unit D will now be described with reference to FIG. 39.

Unit D comprises two parallel conveyors D1 and D2 which are linked by lateral conveyors D3 and D4, so that the crates D5 to D14 may move along the loop formed by these four conveyors.

All the crates have the same structure which will be described with reference to FIGS. 40A to 40C, referring for instance to the empty crate D6.

This crate comprises a bottom D60 with two lateral sides D61 and D62 on two opposing sides.

The lateral side D61 is fixed while the position of the lateral side D62 can be adjusted.

The crate D6 also comprises a back side D63 which can move between a closed position as shown in FIG. 40A and an open position as illustrated on FIG. 40B (retractable back side).

FIG. 40C shows the movable lateral side D62 in a position where it has been moved towards the fixed lateral side D61.

As previously explained, the products P corresponding to the customer's order are supplied to an operator O who puts the product P in a crate D7.

The operator assembles the products in the crate so that they occupy a space smallest as possible.

In other words, each product is in tight contact with at least another product.

Then the operator or an automatic device moves the movable lateral side B72 of the crate to define the space occupied by the products P in the crate D7.

This movement at this stage is suitable if the product(s) to be packed are rigid or cannot be easily deformed. In case the product(s) can be deformed under pressure, the movable lateral side B72 is moved only after the size of the RPS box is determined as explained later.

Each crate is labeled by a barcode or a RFID tag. By a connection between the customer warehouse management system (WMS) and the machine, the order prepared in the crate and the barcode or RFID of the crate are linked until the filling of the box releases the crate. A new link will be created by a new order.

The previously filled and labelled crate D8 is in a measurement area D15 where the size of the RSP box is determined.

As previously explained, the measurement area comprises measurement means for determining the largest length, width and height of the product(s) assembled in the crate which correspond the length H, the width W and the height H of the box designed to define an inner space close to the size of the product(s) which are intended to be housed in it.

As previously explained, on the basis of this measurement, a blank is picked up from one of the stacks A12 to A32, for instance from stack A22 and a box is manufactured according to the process and with the machine previously described.

The crates D9 to D12 move along the loop defined by the four conveyors D1 to D4 and the crate D12 is in the box filling area D16.

In a preferred embodiment, the crates are slightly inclined backwards (by a tilt angle ranging from 5° to 10°) in order to keep the products in position in the corresponding crate during its transfer along the loop of conveyors.

Opposite the filling area D15 of Unit D, the partially erected box F, prepared to house the products present in crate D12 is positioned in Unit E.

A final control can be made at this filling position to check whether the barcodes of the crate D12 and of the box F match.

FIG. 41A shows the relative position of the crate D12 in Unit D and of the partially erected box F in Unit E.

FIG. 41A shows that the box F is also slightly inclined.

A back pusher 150 is positioned at the open side of crate D12 and a counter-pusher D151 is positioned along the back side D123 of the crate D12.

FIG. 41B shows a further step where the back side D123 of the crate is moved to its open position and the pusher D150 is activated.

It can be pointed out that a crate is a secure transportation means for the product(s) to be packed.

FIG. 41C shows the products P in the box F, the products being held between the pusher D150 and the counter-pusher D151.

The pusher D150 and the counter pusher D151 are then lifted up (FIG. 41D) and they are moved to their original position (as shown in FIG. 41A).

After its filling, the box is transferred on the conveyor B4 of Unit E to a position where the box is closed as previously described in reference to FIGS. 9B to 9D.

The examples of the methods according to the invention previously described show that the invention enables to form a box which is closely adapted to the size of the product(s) to be packed, whatever the dimensions of the products while generating very small quantity of waste. The use of padding can be thus avoided.

Moreover, the machine according to the invention is designed to prepare from 1000 to 1200 boxes per hour, each box including one product or several products, different in size or not.

It can further be pointed out that the orientation of the corrugation of the cardboard material has almost no influence on the strength of the final box.

Naturally, in consideration of the foregoing, the present invention is not limited to the embodiments specifically described, but encompasses all variants and in particular variants in which the shape of the blanks is different from those described specifically herein, or variants in which the steps of the methods are carried out according to a different sequence.

1. A blank of corrugated cardboard sheet material consisting of a first body and a second body of rectangular shape which are connected together by means of a line to be cut and designed for forming a set of a first belt and a second belt intended to form a box having a length L, a width W and a height H, the first and the second bodies having different widths and lengths and the line extending along the length of the first and second bodies, the first body having a width larger than the length L and a length larger than at least twice the width W plus the height H and the second body having a width larger than the width W or the height H and a length larger than the length L plus twice the height H or twice the width W.

2. A blank according to claim 1, wherein the first body and the second body are linked together by a separation line which comprises alternate portions of cut and portions of perforations, the first or the second body including tabs, each of them defined by one of said portions of perforations and two cuts connecting the said portion of perforations to a fold line parallel to said portion of perforations.

3. A blank according to claim 1, wherein the first belt having at least three rectangular panels intended to form at least the bottom, the first lateral wall and the top of the box and at least one pair of first flaps being connected on opposing sides of one of said panels, the width of the first body is equal to or larger than the length L plus twice the width w′ of a first flap of the box.

4. A blank according to claim 1, wherein the first belt having at least three rectangular panels intended to form at least the bottom, the first lateral wall and the top of the box and the panel intended to form the top of the box being connected to a third flap which is intended to be glued on the second lateral wall to close the box, the length of the first body is equal to or larger than the height H plus twice the width W plus the width w of said third flap.

5. A blank according to claim 3, wherein the second belt comprising a central panel, having dimensions corresponding to the ones of the panel of the first belt intended to form the bottom of the box, and two secondary panels, each of them connected to a flap, the length of the second body is equal to or larger than the length L plus twice the height H and the width of said flap.

6. A method of manufacturing a set of a first belt and a second belt from a blank according to claim 1 and provided in a stack of blanks, the first and second belts being intended to form a box having a length L, a width W and a height H, wherein, after removal of the blank from the stack, the first body and the second body are separated, at least one body being then cut to reduce its length and/or its width so that it is adapted to the dimensions of the first belt or of the second belt and wherein at least two first parallel fold lines are created in the first body to define at least three main panels of the first belt which are intended to form at least the bottom, the first lateral wall and the top of the box, wherein the main panels intended to form the bottom and the top of the box define the length L and the width W of the box while the main panel intended to form the first lateral wall defines the length L and the height H of the box, and in the second body to define at least a central panel and two secondary panels of the second belt, wherein the secondary panels are intended to form the third and fourth lateral walls of the box and define the height H and the width W of the box.

7. A method according to claim 6, wherein second fold lines, perpendicular to the first fold lines, are created in the first body to define at least one pair of first flaps of the first belt which are connected on opposing sides of one of said main panels by means of said second fold lines.

8. A method according to claim 6, wherein a fourth fold line parallel to said first fold lines is created in the first body to define a third flap connected to the main panel forming the top of the box.

9. A method according to claim 8, wherein only the second body is cut when the length of the first body is less than twice the width W of the box plus three times the height H of the box.

10. A method according to claim 6 wherein the central panel of the second belt has dimensions corresponding to the ones of the main panel of the first belt intended to form the bottom of the box, the first and second belts being intended to be connected together by means of the central panel of the second belt and of the main panel of the first belt forming the bottom of the box, which are overlaid on each other, said first and second belts thus connected being in the shape of a cross.

11. A method according to claim 10, wherein three first parallel fold lines are created in the first body to define four main panels in the first belt, one of them forming the second lateral wall of the box.

12. A method according to claim 10, wherein four first parallel fold lines are created in the second body to define a flap connected to each of the secondary panels of the second belt, by means of one of said first fold lines.

13. A method according to claim 6, wherein the central panel of the second belt is designed to form the second lateral wall of the box and has dimensions corresponding to the length L and the height H of the box, the belts being intended to be connected together to form a T-Shape.

14. A method according to claim 6, wherein the first body and the second body are linked together by a separation line which comprises alternate portions of cut and portions of perforations, the first or the second body including tabs, each of them defined by a portion of perforations and two cuts connecting the said portion of perforations to a fold line parallel to said portion of perforations, the first and the second bodies being separated by punching the tabs to break the portions of perforations.

15. A method of packaging at least one product in a box comprising the step of:
measuring the size of the product(s)
determining the length L, the width W and the height H of the box closely adapted to the size of the product(s) to be packed in the box
choosing a blank corresponding to the length L, the width W and the height H of the box, and according to claim 1
manufacturing a set of a first belt and a second belt according to the method of claim 6, from said blank
gluing the belts together in a position where the first fold lines of the first belt are perpendicular to the first fold lines of the second belt
erecting a box from the joined belts
placing the products(s) in the box and
closing the box.

16. Machine for packaging at least one product in a box comprising:
a unit D for preparing the products and measuring their size
means for determining the length L, the width W and the height H of the box closely adapted to the size of the product or products to be packed in the box
means for determining a type of blank of corrugated cardboard material corresponding to the length L, the width W and the height H of the box and according to claim 1
a unit A including at least two stacks of blanks of different types
a unit B including splitting means for separating the first body and the second body of said blank and a first body transformation line, respectively a second body transformation line to transform the first body, respectively the second body into a first belt, respectively a second belt
a unit C for joining the first and second belts in a cross shape or a T shape, and for forming the joined belts into an at least partially erected box F and
a unit E for the filling the at least partially erected box F with the product or products for which it is designed and for closing the box.

17. Machine according to claim 16, wherein the first body transformation line, respectively the second body transformation line includes cutting means for reducing the length and/or the width of the first body, respectively the second body.

18. Machine according to claim 16 wherein unit D comprises crates for the transportation of the products, each of them including a bottom, two lateral sides, one of them being fixed and the other movable, and a retractable backside, the unit E for filling the products being arranged to fill said products laterally.
